(19) United States
(12) Patent Application Publication
(10) Pub. No.: US 2013/0061013 A1
(43) Pub. Date: Mar. 7, 2013

(54) STORAGE SYSTEM, AND APPARATUS AND METHOD FOR CONTROLLING STORAGE

(71) Applicant: Hirotomo TOKORO, Yokohama (JP)

(72) Inventor: Hirotomo TOKORO, Yokohama (JP)

(73) Assignee: FUJITSU LIMITED, Kawasaki-shi (JP)

(21) Appl. No.: 13/591,491

(22) Filed: Aug. 22, 2012

(30) Foreign Application Priority Data
Sep. 1, 2011 (JP) 2011-190274

(51) Int. Cl. G06F 12/02

(52) U.S. Cl. 711/162; 711/E12.002

(57) ABSTRACT

A write control unit executes, for example, asynchronously a process of writing data to a first volume and a process of generating a code corresponding to the written data with respect to each partial area in the first volume and registering the generated codes in a code storing unit. The replication control unit replicates data of a replication target area in the first volume to a second volume, and determines partial areas of the replication target area, in which partial areas identical data is stored, based on the codes registered in the code storing unit and allocates the same physical storage area to partial areas of the second volume, which partial areas correspond to the determined partial areas.

### CROSS-REFERENCE TO RELATED APPLICATION

This application is based upon and claims the benefit of priority of the prior Japanese Patent Application No. 2011-190274, filed on Sep. 1, 2011, the entire contents of which are incorporated herein by reference.

### FIELD

The embodiments discussed herein are related to a storage system, a storage control apparatus, and a storage control method.

### BACKGROUND

Storage systems which use a plurality of storage devices, such as hard disk drives (HDDs), are in wide use in recent years. Because the amount of data stored in storage systems has increased from year to year, a technology to efficiently use storage area inside such a storage system and reduce the amount of physical storage area used for real has gained attention.

One technology to reduce the amount of physical storage area is thin provisioning. Thin provisioning is designed to initially prepare physical storage area corresponding to only an actual storage data amount, instead of preparing physical storage area corresponding to the entire storage amount requested, and provide the requested storage amount as virtual volumes.

In addition, another technology to reduce the amount of physical storage area is de-duplication. De-duplication is the process of identifying duplicates in stored data and storing only one of the duplicates in the physical storage area while removing the remaining duplicates. For example, in some backup systems, duplicated data is excluded from a backup source volume, and only data stored in physical storage area in the volume from which the duplicated data has been excluded is copied to a backup volume.
Japanese Laid-open Patent Publication No. 2010-271808
Japanese Laid-open Patent Publication No. 2009-48497
Japanese Laid-open Patent Publication No. 2008-282382

Along with an increase in demand for backing up data stored in storage systems, the storage capacity required as a backup destination has increased. Accordingly, it has been a challenge to reduce the storage amount in the backup destination.

### SUMMARY

According to one aspect, there is provided a storage system including a plurality of storage apparatuses; and a storage control apparatus configured to control reading and writing of data with respect to a volume made up of part of physical storage areas of the storage apparatuses. The storage control apparatus includes a memory that stores one or more codes and a processor. The processor executes processing to write data to a first volume in response to a request from a host apparatus and generate a code corresponding to written data with respect to each of partial areas formed by dividing the first volume, and then register, in the memory, the generated codes in association with the individual partial areas. The processor also executes processing to replicate, on receiving a replication request regarding a replication target area in the first volume, data of the replication target area to a second volume made up of different part of the physical storage areas from part of the physical storage areas constituting the first volume and determine, from among partial areas in the replication target area, partial areas in which identical data is stored based on the codes registered in the memory, and then allocate the same physical storage area to partial areas of the second volume corresponding to the partial areas in which the identical data is stored.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of a storage system according to a first embodiment;

FIG. 2 illustrates an example of an overall configuration of a storage system according to a second embodiment;

FIG. 3 illustrates an example of a hardware configuration of a controller module;

FIG. 4 is a block diagram illustrating a configuration example of processing functions of the controller module;

FIG. 5 illustrates allocation of physical storage areas to a transaction volume and a replica volume;

FIG. 6 illustrates an example of information registered in a pool area management table;

FIG. 7 illustrates an example of information registered in a transaction volume management table;

FIG. 8 illustrates an example of information registered in a replica volume management table;

FIG. 9 is an example of information registered in a replication range setup table;

FIG. 10 illustrates an example of processing performed in a data write operation to the transaction volume;

FIG. 11 illustrates an example of a replica volume generating process;

FIG. 12 illustrates an example of processing performed in response to a write request newly issued when code calculation has yet to be completed;

FIG. 13 is a first flowchart illustrating an example of data write procedures with respect to the transaction volume according to a request from a host device;

FIG. 14 is a second flowchart illustrating the example of data write procedures with respect to the transaction volume according to the request from the host device;

FIG. 15 is a flowchart illustrating an example of code calculation procedures;

FIG. 16 is a first flowchart illustrating an example of replica volume generating procedures;

FIG. 17 is a second flowchart illustrating the example of the replica volume generating procedures;

FIG. 18 illustrates an example of a restoration process using the replica volume;

FIG. 19 illustrates an example of information registered in a transaction volume management table according to a third embodiment;

FIG. 20 is a flowchart illustrating an example of procedures for reducing the storage amount of the transaction volume; and

FIG. 21 is a flowchart illustrating an example of replica volume generating procedures according to the third embodiment.

### DESCRIPTION OF EMBODIMENTS

Several embodiments will be described below with reference to the accompanying drawings, wherein like reference numerals refer to like elements throughout.

### (a) First Embodiment

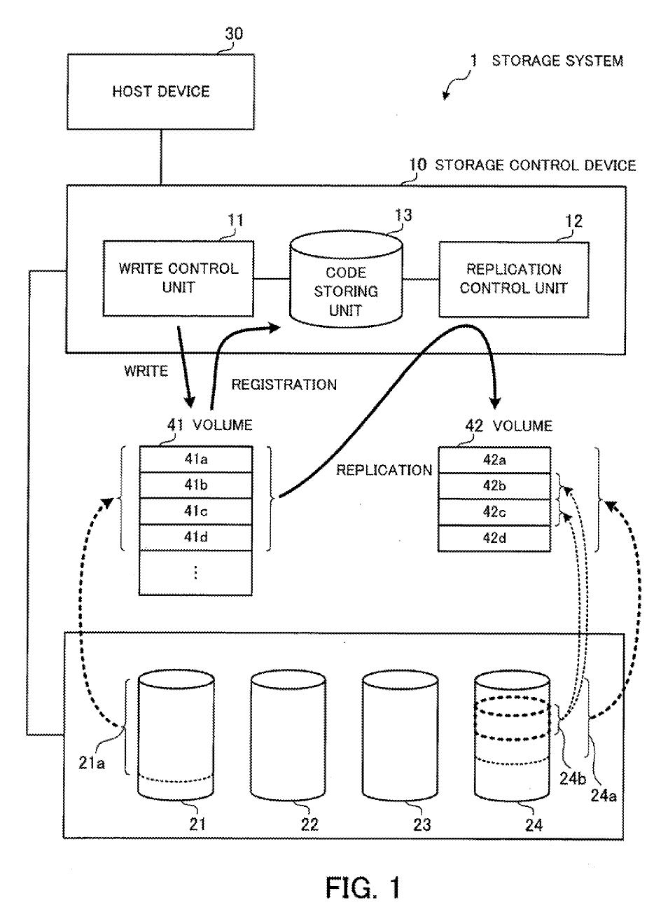

FIG. 1 illustrates a configuration example of a storage system according to a first embodiment.

A storage system 1 includes a storage control device 10 and a plurality of storage devices. The storage devices included in the storage system 1 are nonvolatile storage devices, such as HDDs and solid state drives (SSDs). FIG. 1 illustrates storage devices 21 to 24 as an example of the storage devices included in the storage system 1. In addition, to the storage control device 10, a host device 30 is connected.

The storage control device 10 controls data access processing for accessing data in the storage devices 21 to 24. The storage control device 10 controls reading and writing of data with respect to volumes, each made up of a part of physical storage areas of the storage devices 21 to 24. Each of volumes 41 and 42 illustrated in FIG. 1 is such a volume.

The storage control device 10 includes a write control unit 11, a replication control unit 12, and a code storing unit 13. Individual processes performed by the write control unit 11 and the replication control unit 12 are implemented, for example, by a central processing unit (CPU) of the storage control device 10 executing predetermined programs. In addition, the code storing unit 13 is implemented, for example, as storage area of a nonvolatile storage device provided inside the storage control device 10.

In response to a request from the host device 30, the write control unit 11 writes data to the volume 41 (the first volume). In addition, with respect to each of partial areas formed by dividing the volume 41, the write control unit 11 generates a code corresponding to a set of data written therein, and registers, in the code storing unit 13, the generated codes in association with the individual partial areas. The codes registered in the code storing unit 13 are individually unique values according to each set of written data, and are, for example, hashes calculated based on each set of written data.

The write control unit 11 carries out, for example, asynchronously a data write operation for the volume 41 and a code generation operation based on written data according to a request from the host device 30. In this case, after writing data in a predetermined partial area of the volume 41, the write control unit 11 generates a code based on the data written in the partial area at an arbitrary timing and registers the generated code in the code storing unit 13.

On receiving a replication request regarding a replication target area in the volume 41 from, for example, the host device 30, the replication control unit 12 replicates data of the replication target area to another volume 42 (the second volume) to thereby generate a replica volume. The volume 42 is made up of, among the physical storage areas implemented by the storage devices 21 to 24, a physical storage area different from that of the volume 41.

In addition to generating the replica volume as described above, the replication control unit 12 determines partial areas storing identical data among the partial areas in the replication target area, based on the codes registered in the code storing unit 13. Subsequently, the replication control unit 12 allocates the same physical storage area to partial areas in the volume 42, which partial areas correspond to the partial areas storing identical data. That is, with respect to a partial area group holding identical data among the partial areas of the volume 42, the replication control unit 12 stores actual data in only one partial area of the partial area group while not storing the actual data in the rest of the partial area group. According to such a process, the amount of physical storage areas allocated to the volume 42 is reduced.

For example, assume that partial areas 41a to 41d of the volume 41 are implemented by a physical storage area 21a of the storage device 21. Assume further that a request for a replication process is issued in which request the partial areas 41a to 41d of the volume 41 are indicated as a replication target area.

The replication control unit 12 stores data of the partial areas 41a to 41d, for example, in a physical storage area 24a of the storage device 24, to thereby generate the volume 42 made up of replicas of the partial areas 41a to 41d. That is, partial areas 42a to 42d of the generated volume 42 correspond to the partial areas 41a to 41d, respectively, of the volume 41 which is a replication source.

Assume here that data of the partial area 41b and data of the partial area 41c are identical. The replication control unit 12 determines that the data of the partial area 41b and the data of partial area 41c are identical since codes individually associated with the partial areas 41b and 41c in the code storing unit 13 match each other. The replication control unit 12 allocates the same physical storage area to the partial areas 42b and 42c of the volume 42 corresponding to the partial areas 41b and 41c, respectively.

For example, the replication control unit 12 stores data of the partial area 41b of the volume 41, as the data of the partial area 42b, in a physical storage area 24b within the physical storage area 24a of the storage device 24. Further, the replication control unit 12 allocates the physical storage area 24b also to the partial area 42c in common with the partial area 42b, instead of storing actual data of the partial area 42c in a different physical storage area from the physical storage area 24b.

The following method may be used to allocate the same physical storage area to different partial areas. The replication control unit 12 records, with respect to each partial area of the volume 42, actual data and location information which indicates a location of a physical storage area in which the actual data is stored. According to the method, the replication control unit 12 records the actual data and location information for the partial area 42b. However, for the partial area 42c, the replication control unit 12 records not the actual data but only the location information. With this, the same physical storage area is allocated to the partial areas 42b and 42c.

Another method may be used in which the replication control unit 12 registers, in table information, each partial area of the volume 42 in association with location information of a physical storage area in which corresponding actual data is stored. According to the method, the replication control unit 12 registers, in the table, the same location information for individual entries of the partial areas 42b and 42c, to thereby allocate the same physical storage area to the partial areas 42b and 42c.

As described above, by allocating the same physical storage area, in the volume 42, to the partial areas in which identical data is recorded, the amount of physical storage area prepared for the volume 42 is reduced. Accordingly, the usage of physical storage areas provided in the storage system 1 is reduced, which improves the usage efficiency of the physical storage areas.

In addition, the replication control unit 12 determines the presence or absence of partial areas in which identical data is recorded by referring to the code storing unit 13 in which preliminarily generated codes are registered. Therefore, there is no need to calculate codes at the time of generating a replica volume. This reduces the time required for the replica volume generating process.

On the other hand, the write control unit 11 calculates codes based on data written to the volume 41, however, does not determine the sameness of the data among the partial areas. In addition, the write control unit 11 may asynchronously carry out a data write operation to the volume 41 and a code calculation operation based on the written data. This reduces the influence of the code calculation operation on access processing to the volume 41 according to a request from the host device 30. As a result, it is possible to reduce the amount of physical storage areas used in the storage system 1, which improves the usage efficiency of the physical storage areas, while decreasing, as little as possible, the speed of a write operation to a storage device performed according to a request of the host device 30.

Note that the replication control unit 12 may generate the volume 42 as a virtual volume. In this case, physical storage areas are allocated only to, among the partial areas of the volume 42, partial areas in which data is actually recorded, and physical storage areas are not allocated to partial areas in which no data is recorded. This further reduces the amount of physical storage areas allocated to the volume 42.

### (b) Second Embodiment

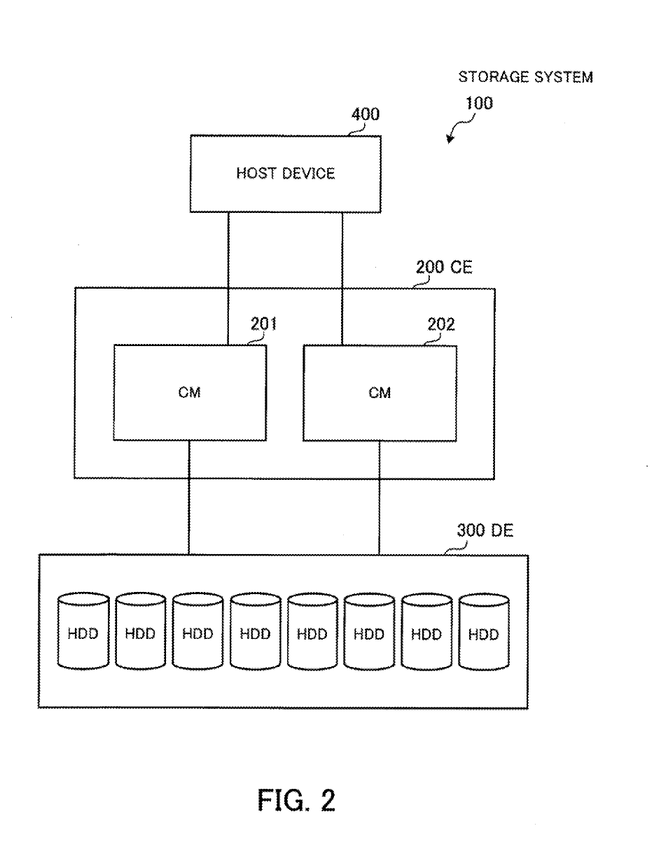

FIG. 2 illustrates an example of an overall configuration of a storage system according to a second embodiment. A storage system 100 of FIG. 2 includes a controller enclosure (CE) 200 and a drive enclosure (DE) 300. In addition, to the CE 200, a host device 400 is connected.

The CE 200 includes controller modules (CMs) 201 and 202. Each of the CMs 201 and 202 reads and writes data from and to a storage device in the DE 300 in response to an In/Out (I/O) request from the host device 400. The CMs 201 and 202 manage physical storage areas, which are implemented by storage devices of the DE 300, using Redundant Arrays of Inexpensive Disks (RAID), and control access to the physical storage areas.

Note that the CMs 201 and 202 may be connected to each other, for example, via a router. In addition, a single CM or three or more CMs may be provided in the CE 200. Note however that providing a plurality of CMs increases redundancy of an access control system for the DE 300, which improves reliability of access control processing.

The DE 300 includes a plurality of storage devices to be access control targets of the CMs 201 and 202. The DE 300 of this embodiment is a disk array apparatus including HDDs as storage devices. Note that other types of nonvolatile storage devices, such as SSDs, may be used as storage devices of the DE 300. In addition, a plurality of DEs 300 may be connected to the CE 200.

In response to a user operation, the host device 400 makes a request to the CMs 201 and 202 for access to an HDD of the DE 300. For example, in response to a user operation, the host device 400 is able to read data from an HDD of the DE 300 and write data to an HDD of the DE 300 via one of the CMs 201 and 202.

Note that both the CMs 201 and 202 of the CE 200 have a similar configuration and are able to carry out similar processing. Accordingly, the following gives a description of the CM 201 only and the description of the CM 202 is omitted.

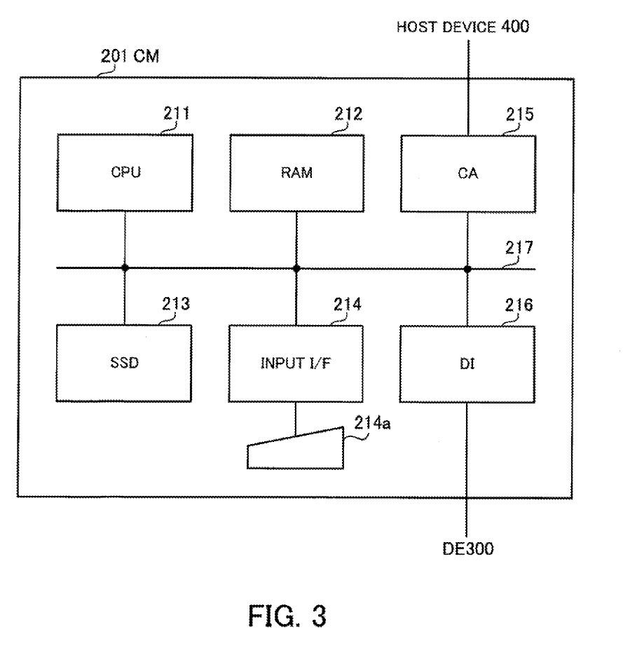

FIG. 3 illustrates an example of a hardware configuration of a CM.

As for the CM 201, a CPU 211 exercises overall control over the entire CM 201. To the CPU 211, a random access memory (RAM) 212 and a plurality of peripherals are connected via a bus 217. The RAM 212 is used as a main storage device of the CM 201 and temporarily stores at least part of a program to be executed by the CPU 211 and various types of data required for processing implemented by the program.

To the CPU 211, various peripherals such as an SSD 213, an input interface (I/F) 214, a channel adapter (CA) 215, and a drive interface (DI) 216 are connected.

The SSD 213 is used as a secondary storage device of the CM 201 and stores the program to be executed by the CPU 211 and various types of data required for implementation of the program. Note that, as the secondary storage device, another type of nonvolatile storage device such as an HDD may be used.

To the input I/F 214, an input device 214a equipped with operation keys and the like is connected. The input I/F 214 outputs, to the CPU 211, a signal according to an operational input to the input device 214a.

The CA 215 carries out interface processing for transmitting and receiving data between the host device 400 and the CM 201. The CA 215 and the host device 400 communicate with each other according to, for example, Fibre Channel (FC) standards.

The DI 216 carries out interface processing for transmitting and receiving data between the DE 300 and the CM 201. The DI 216 and the DE 300 communicate with each other according to, for example, the SAS (Serial Attached SCSI (small computer system interface)) standards.

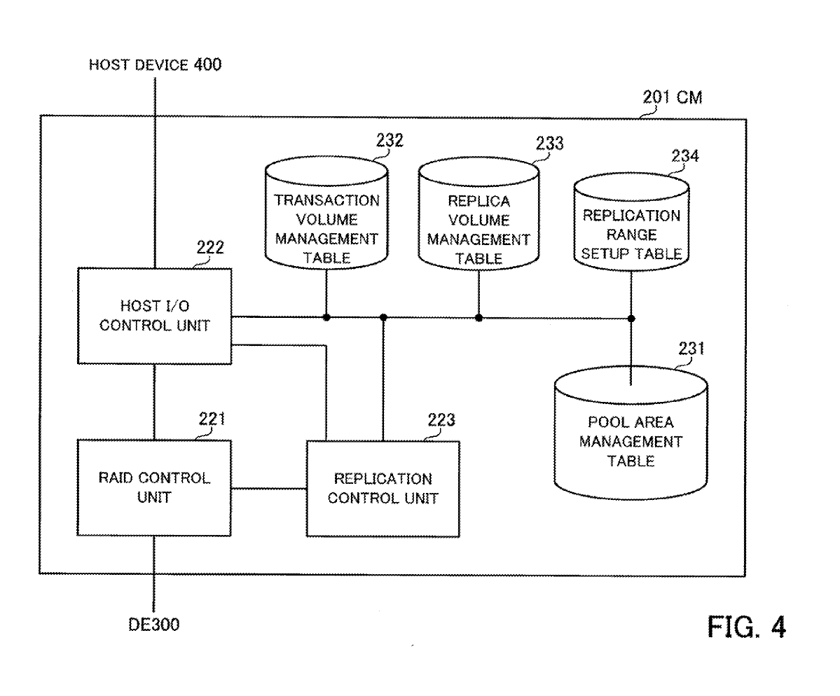

FIG. 4 is a block diagram illustrating a configuration example of processing functions of a CM.

The CM 201 includes a RAID control unit 221, a host I/O control unit 222, and a replication control unit 223. Processes of the RAID control unit 221, the host I/O control unit 222, and the replication control unit 223 are implemented, for example, by the CPU 211 of the CM 201 executing a predetermined program.

In a storage device of the CM 201, a pool area management table 231, a transaction volume management table 232, a replica volume management table 233, and a replication range setup table 234 are stored. The individual tables are stored, for example, in the SSD 213.

The RAID control unit 221 accesses an HDD of the DE 300 in response to a request from the host I/O control unit 222 or the replication control unit 223. When making access to an HDD of the DE 300, the RAID control unit 221 performs access control based on setup information related to the RAID (the RAID level, the number of disks constituting the RAID, and the like) set for an access destination area.

For example, when receiving a data write request from the host I/O unit 222, the RAID control unit 221 performs a write operation in such a manner that data is redundantly stored, based on the setup information related to the RAID. Assume here that control is carried out using a RAID 5 configuration with six disks (i.e., the number of disks, “6”). The RAID control unit 221 divides data received from the host I/O control unit 222, and records five successive pieces of the divided data and parity based on the five pieces of the divided data in such a manner as to be distributed to areas of the same stripe number in the six HDDs.

The host I/O control unit 222 receives an I/O request for a transaction volume from the host device 400. The transaction volume is a logical volume available for a user, and physical storage areas of the transaction volume are provided by HDDs in the DE 300. The user is able to read and write data with respect to the transaction volume by transmitting an I/O request to the CM 201 from the host device 400.

The transaction volume is implemented as a virtual volume made up of physical storage areas allocated from a pool area. The pool area includes, among unused physical storage areas in the HDDs of the DE 300, areas allocatable for the transaction volume (and a replica volume to be described below). Addresses indicating locations of individual areas included in the pool area are registered in the pool area management table 231.

On receiving a write request for the transaction volume from the host device 400, the host I/O control unit 222 acquires a physical storage area of a data write destination from the pool area management table 231. The host I/O control unit 222 notifies the RAID control unit 221 of an address (logical block address, LBA) indicating the acquired physical storage area and data to be written, and requests the RAID control unit 221 to write the data to the physical storage area. In addition, the host I/O control unit 222 registers, in the transaction volume management table 232, the address indicating the acquired physical storage area in association with a data write location in the transaction volume. According to such processing, a physical storage area for the transaction volume is dynamically allocated from the pool area only for the area in which data is actually written.

On receiving a read request for a transaction volume from the host device 400, the host I/O control unit 222 determines an address indicating a read area by referring to the transaction volume management table 232. The host I/O control unit 222 notifies the RAID control unit 221 of the address indicating the read area, and requests the RAID control unit 221 to read data from the read area. When the RAID control unit 221 reads the data in response to the request, the host I/O control unit 222 transmits the read data to the host device 400.

Further, on receiving, from the host device 400, a designation of a replication target area in the transaction volume as well as a replication request for the designated replication target area, the host I/O control unit 222 notifies the replication control unit 223 of information indicating the replication target area and requests the replication control unit 223 to perform a process of generating a replication volume (hereinafter, referred to as the “replication volume generating process”).

In response to the request from the host I/O control unit 222, the replication control unit 223 performs the replication volume generating process. The replication volume is used as a backup for, for example, an area designated as a replication target in the corresponding transaction volume (hereinafter referred to as the “replication target area”). The replica volume is implemented as a virtual volume made up of physical storage areas allocated from the pool area, which are shared with the transaction volume. The replication control unit 223 registers, in the replica volume management table 233, partial areas of the replica volume in association with addresses of physical storage areas allocated to the individual partial areas.

The replication control unit 223 determines addresses of the physical storage areas allocated to the replication target area by referring to the transaction volume management table 232. Subsequently, the replication control unit 223 notifies the RAID control unit 221 of the determined addresses and requests the RAID control unit 221 to read data from the physical storage areas. In addition, the replication control unit 223 acquires, from the pool area management table 231, physical storage areas corresponding to, within the replication target area, areas in which data is stored (that is, areas to which physical storage areas have been allocated). The replication control unit 223 requests the RAID control unit 221 to copy the data read by the RAID control unit 221 to the acquired physical storage areas. According to such processing, physical storage areas for the replica volume are dynamically allocated from the pool area only for the area in which data is actually written.

When generating a replica volume, the replication control unit 223 carries out data de-duplication in the replica volume and data compression for each partial area, as described below. The data de-duplication is a process to allocate the same physical storage area to, among partial areas of the replica volume, partial areas in which identical data is stored. Using such data de-duplication and data compression, the amount of physical storage areas allocated to the replica volume is reduced.

Note that, when generating a replica volume, the replication control unit 223 registers, in the replication range setup table 234, addresses individually indicating physical storage areas allocated to the replication target area in the transaction volume. The replication range setup table 234 is referenced by the host I/O control unit 222 when a write request for the transaction volume is issued by the host device 400 during the replication volume generating process.

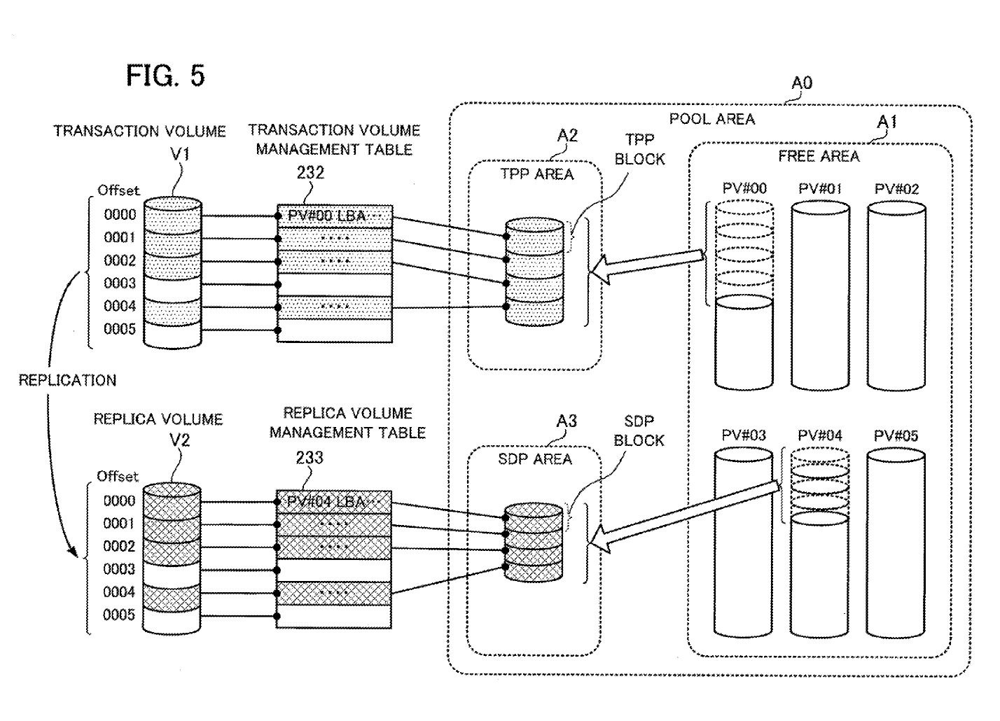

FIG. 5 illustrates allocation of physical storage areas to a transaction volume and a replica volume.

FIG. 5 illustrates, as an example, a case of generating a replica volume V2 by replicating at least part of a transaction volume V1. “Offsets” given to the transaction volume V1 individually indicate partial areas formed by dividing the transaction volume V1 into fixed size segments. Hereinafter, the partial areas are referred to as the “offsets”, and an offset with number X is denoted by “Offset #X”. FIG. 5 illustrates, as an example, a case in which Offsets #0000 to #0005 of the transaction volume V1 are replicated to the replica volume V2.

As described above, both the transaction volume V1 and the replica volume V2 are implemented as virtual volumes. As for the transaction volume V1, physical storage areas are allocated only to offsets in which data is stored. The physical storage areas allocated to the transaction volume V1 are registered in the transaction volume management table 232. According to the example of FIG. 5, data is stored in Offsets #0000 to #0002, and #0004 of the transaction volume V1. In this case, location information indicating the physical storage areas allocated to the individual offsets is registered in entries corresponding to Offsets #0000 to #0002, and #0004 in the transaction volume management table 232.

As also for the replica volume V2, physical storage areas are allocated only to offsets in which data is stored. The physical storage areas allocated to the replica volume V2 are registered in the replica volume management table 233. According to the example of FIG. 5, since data is stored in Offsets #0000 to #0002, and #0004 of the transaction volume V1, data is stored in Offsets #0000 to #0002, and #0004 of the replica volume V2. In this case, location information indicating the physical storage areas allocated to the individual offsets is registered in entries corresponding to Offsets #0000 to #0002, and #0004 in the replica volume management table 233.

On the other hand, a pool area A0 of FIG. 5 is a collection of physical storage areas implemented by HDDs in the DE 300. The pool area A0 includes a free area A1, a thin provisioning pool (TPP) area A2, and a snap data pool (SDP) area A3. While the areas included in the free area A1 are not in use, the areas included in the TPP area A2 and the SDP area A3 are in use.

Physical storage areas for the transaction volume V1 and the replica volume V2 are allocated from the free area A1. In the free area A1, for example, physical storage areas allocatable for the transaction volume V1 and the replica volume V2 are prepared as a plurality of pool volumes. According to the example of FIG. 5, six pool volumes PVs #00 to #05 are prepared in the free area A1. Each of physical storage areas to be allocated to the transaction volume V1 or the replica volume V2 is identified by a volume number for identifying a pool volume prepared in the free area A1, a logical block address (LBA) indicating the start position in the pool volume, and the number of blocks (the number of LBAs) indicating the length (capacity) from the start position to the end position.

Each pool volume is made up of one or more HDDs according to a RAID configuration. Assume in this embodiment that control is carried out using the above-described “RAID 5 configuration with six disks”. Each pool volume is made up of six HDDs in the DE 300. An LBA in a pool volume with a volume number indicates the same location in the individual six HDDs belonging to a pool volume corresponding to the volume number. Accordingly, when physical storage areas indicated by a volume number and an LBA are allocated to the transaction volume V1 or the replica volume V2, physical storage areas indicated by the same LBA in the six HDDs are actually allocated.

When a request for data write to an offset in the transaction volume 1 is issued, a physical storage area is extracted from the free area A1. Then, the extracted physical storage area is allocated to the offset, and data is stored in the allocated physical storage area. The TPP area A2 is basically a logical area to which physical storage areas allocated to the transaction volume V1 belong. A physical storage area for each offset, belonging to the TPP area A2, is hereinafter referred to as the “TPP block”. According to the example of FIG. 5, TPP blocks are individually allocated to, among the offsets in the transaction volume V1, only Offsets #0000 to #0002, and #0004 in which data is stored. Note that all TPP blocks have the same capacity.

On the other hand, for each offset of the replica volume V2, in which offset data is to be stored, a physical storage area extracted from the free area A1 is allocated. The SDP area A3 is a logical area to which physical storage areas allocated to the replica volume V2 in the end belong. A physical storage area for each offset, belonging to the SDP area A3, is hereinafter referred to as the “SDP block”. According to the example of FIG. 5, SDP blocks are individually allocated to, among the offsets of the replica volume V2, only Offsets #0000 to #0002, and #0004 in which data is stored.

In each offset of the replica volume V2, in which offset data is stored, data stored in a corresponding offset of the transaction volume V1 is written in a compressed form. Therefore, the capacity of each SDP block allocated to an offset of the replica volume V2 is generally smaller than the capacity of a TPP block.

Further, in the replica volume V2, “de-duplication” is carried out which allocates the same SDP block to offsets in which identical data is stored, as described below. Due to the de-duplication, the number of SDP blocks allocated to the replica volume V2 may be less than the number of TPP blocks allocated to the replication target area in the transaction volume V1. With this, it is possible to further reduce the capacity of physical storage areas allocated to the replica volume V2.

Note that a condition illustrated in FIG. 5 with respect to the replica volume V2 as well as the replica volume management table 233 and the SDP blocks corresponding to the replica volume V2 is obtained when the replica volume generating process for the replica volume V2 is completed. However, during the replica volume generating process for the replica volume V2, TPP blocks are temporarily allocated to offsets of the replica volume V2, and SDP blocks are subsequently allocated in place of the TPP blocks, as described below.

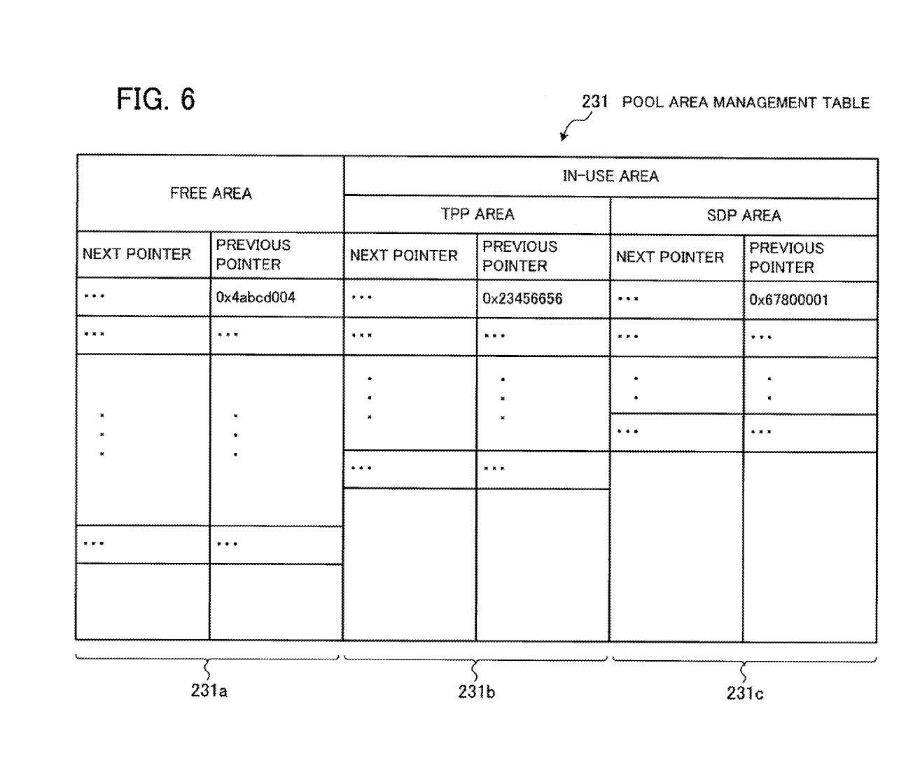

FIG. 6 illustrates an example of information registered in a pool area management table.

In the pool area management table 231, information is registered with respect to, of the pool area, free areas allocatable as a transaction volume and a replica volume and allocated areas (in-use areas). As for the in-use areas, TPP areas and SDP areas are individually managed. Note that FIG. 6 illustrates a table corresponding to a single pool volume provided in the pool area. However, in practice, a table as illustrated in FIG. 6 is registered in the pool area management table 231 for each pool volume.

The free areas are managed by a linked list 231a using entries, each of which is made up of a combination of a “next pointer” and a “previous pointer”. One entry indicates a continuous storage area (an area indicated by sequential LBAs) in a pool volume. In the “next pointer”, the first LBA of a storage area indicated by the next entry is registered. In the “previous pointer”, the end LBA of a storage area indicated by the previous entry is registered. In the “previous pointer” of the first entry in the linked list 231a, the end LBA of a storage area indicated by the last entry in the linked list 231a is registered. On the other hand, in the “next pointer” of the last entry in the linked list 231a, the first LBA of a storage area indicated by the first entry in the linked list 231a is registered.

Similarly, the TPP areas are also managed by a linked list 231b using entries, each of which is made up of a combination of a “next pointer” and a “previous pointer”. Further, the SDP areas are also managed by a linked list 231c using entries, each of which is made up of a combination of a “next pointer” and a “previous pointer”.

When a TPP block is allocated from the free areas, the linked list 231a is rewritten in such a manner that a storage area corresponding to the TPP block is excluded from the free areas. With this, the linked list 231b is rewritten so that the TPP block is added to the TPP areas. On the other hand, when a storage area having been used as a TPP block is released, the linked list 231b is rewritten so that the storage area is excluded from the TPP areas. Together with this, the linked list 231a is rewritten so that the storage area excluded from the TPP areas is added to the free areas.

In a similar fashion, when an SDP block is allocated from the free areas, the linked list 231a is rewritten in such a manner that a storage area corresponding to the SDP block is excluded from the free areas. With this, the linked list 231c is rewritten so that the SDP block is added to the SDP areas. On the other hand, when a storage area having been used as an SDP block is released, the linked list 231c is rewritten so that the storage area is excluded from the SDP areas. Together with this, the linked list 231a is rewritten so that the storage area excluded from the SDP areas is added to the free areas.

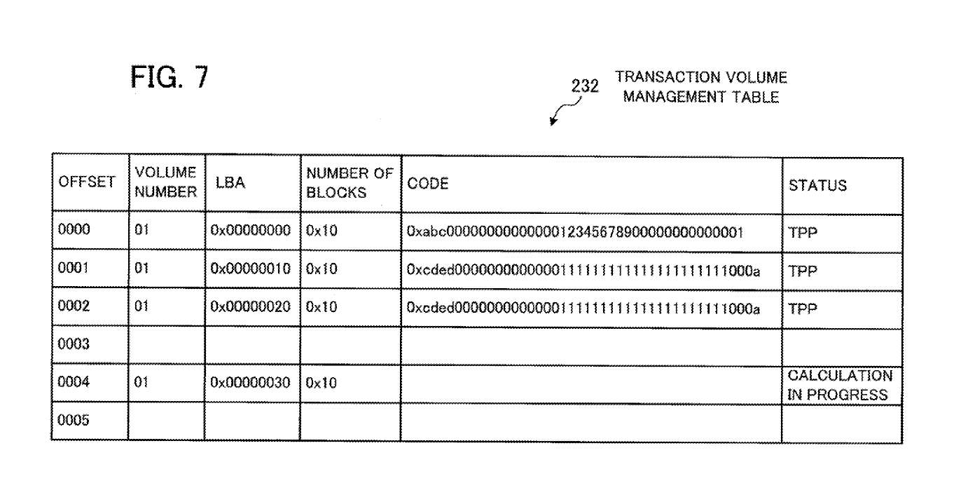

FIG. 7 illustrates an example of information registered in a transaction volume management table.

In the transaction volume management table 232, an entry is provided for each offset in the transaction volume. Registered in each entry are location information of a physical storage area allocated to a corresponding offset, a code based on data stored in the offset, and a status of the offset.

As for the location information of an allocated physical storage area, the following are registered: a volume number for identifying a pool volume to which the physical storage area belongs; an LBA indicating the start position of the physical storage area; and the number of blocks indicating the capacity of the physical storage area. Note that blocks counted as “the number of blocks” are logical blocks identified by one LBA in the pool volume, and are different from TPP blocks and SDP blocks. In the case where a TPP block is allocated to an offset, the number of blocks becomes a fixed value.

Each code is calculated based on data stored in a corresponding offset, and takes a unique value according to the calculation base data. For example, hashes may be used as such codes.

Each status indicates the status of a corresponding offset, and one of “calculation in progress”, “TPP”, and “SDP” is set. The status “calculation in progress” indicates that, although a TPP block has been allocated to the offset, calculation of a code based on data to be stored in the allocated TPP block is yet to be completed. The status “TPP” indicates that a TPP block has been allocated to the offset and the code calculation has been completed. For example, when a value is registered in a field for the code in an entry, the status in the entry is updated from “calculation in progress” to “TPP”. The status “SDP” indicates that an SDP block has been allocated to the offset. Note that the case in which an SDP block is allocated to an offset of a transaction volume takes place, for example, when the transaction volume is logically restored using a physical storage area of a replica volume (that is, an SDP block) after data in the transaction volume is partially destroyed or the like.

Note that a plurality of transaction volumes may be set. In such a case, the transaction volume management table 232 is individually generated for each of the transaction volume.

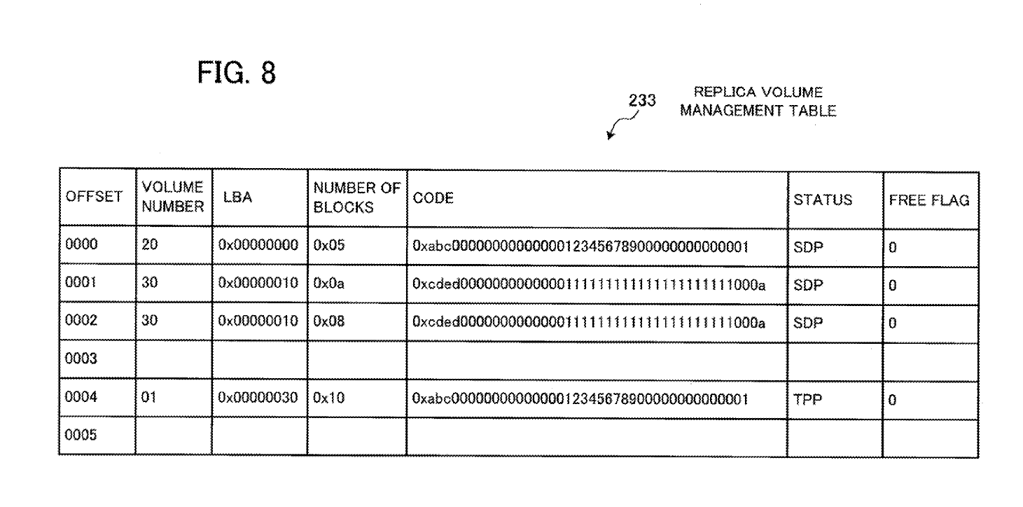

FIG. 8 illustrates an example of information registered in a replica volume management table.

In the replica volume management table 233, an entry is provided for each offset in the replica volume. Registered in each entry of the replica volume management table 233 are location information of a physical storage area allocated to a corresponding offset, a code based on data stored in the offset, and a status of the offset, as in the case of the transaction volume management table 232.

Further, a free flag is also registered in each entry of the replica volume management table 233. The free flag has an initial value of “0”, and is set to “1” when the status is “TPP” and a different TPP block has been allocated to the same offset in the transaction volume. The case in which the free flag is set to “1” takes place when a data write request with respect to a corresponding offset is newly issued from the host device 400 while code calculation based on data stored in the offset has yet to be completed.

Note that a plurality of replica volumes may be generated based on a single transaction volume at different timings. In such a case, the replica volume management table 233 is individually generated for each replica volume each time when a replica volume generating process is started.

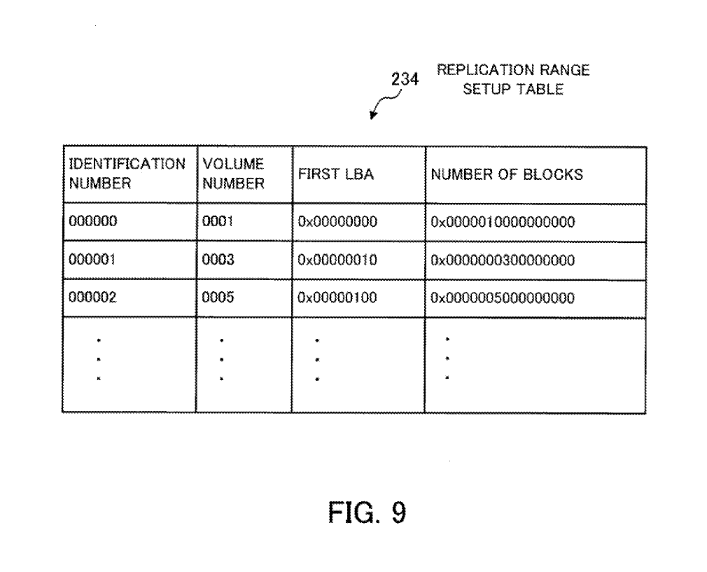

FIG. 9 is an example of information registered in a replication range setup table.

The replication range setup table 234 is for holding location information of individual physical storage areas allocated to a replication target range in the transaction volume when the replication target range is designated and a request for generating a replica volume is issued. In the replication range setup table 234, an entry is provided for each continuous physical storage area belonging to the same pool volume. For each entry, an identification number is given, and also location information indicating a corresponding physical storage area is registered. As for the location information, the following are registered: a volume number for identifying a pool volume to which the physical storage area belongs; an LBA indicating the start position of the physical storage area; and the number of blocks indicating the length (capacity) of the physical storage area are registered.

The replication range setup table 234 is deleted when the process of generating a corresponding replica volume is completed. Note that the replication range setup table 234 may be stored in a volatile storage device inside the CM 201, such as the RAM 212.

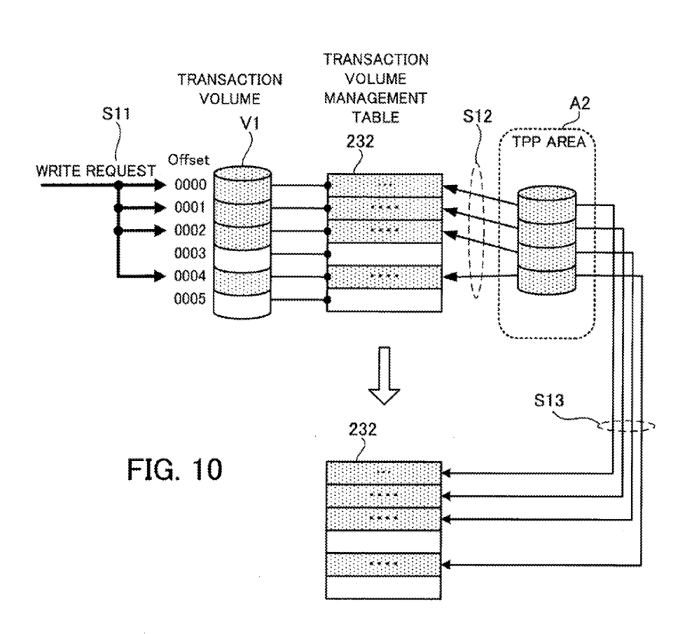

Next described is a replica volume generating process. FIG. 10 illustrates an example of processing performed in a data write operation to the transaction volume.

On receiving a request, from the host device 400, for data write to no-data storing areas in the transaction volume, in which areas no data is stored, the host I/O control unit 222 acquires TPP blocks from the free area, and allocates the acquired TPPs to data write target offsets in the transaction volume. Assume in the example of FIG. 10 that the host device 400 requests data write to Offsets #0000 to #0002, and #0004 in the transaction volume V1 (Step S11).

In response to the write request, the host I/O control unit 222 acquires, from the free area, physical storage areas (TPP blocks) respectively corresponding to Offsets #0000 to #0002, and #0004 and registers location information of the acquired physical storage areas in the transaction volume management table 232 (Step S12). At this point, the host I/O control unit 222 updates the pool area management table 231 to thereby exclude the acquired physical storage areas from the free area and add the acquired physical storage areas to the TPP area A2. With this, the acquired physical storage areas are treated as TPP blocks.

The host I/O control unit 222 performs the above-described process of registration to the transaction volume management table 232, and also passes the location information of the acquired TPP blocks and data to be written to each of the TPP blocks on to the RAID control unit 221 and requests the RAID control unit 221 to write the data to the TPP blocks. With this, the data is written to the TPP blocks respectively allocated to Offsets #0000 to #0002, and #0004.

Further, the host I/O control unit 222 calculates codes based on the data written individually to Offsets #0000 to #0002, and #0004, and registers the calculated codes in the transaction volume management table 232 (Step S13). Thus, the codes used for replication processing are calculated and registered in the transaction volume management table 232 before a replication request for an area in the transaction volume V1 is issued. This enables efficient execution of de-duplication at the time of the replication processing.

Note however that the host I/O control unit 222 carries out asynchronously the data write operation to the TPP blocks according to the request from the host device 400 and the code calculation operation based on the written data. That is, the host I/O control unit 222 carries out the code calculation operation based on the written data at an arbitrary timing after data write to the TPP blocks is completed. With this, the time required from receiving the write request from the host device 400 to completing the requested write operation and then responding to the host device 400 is shortened, and the influence of the code calculation operation on the host I/O process is reduced.

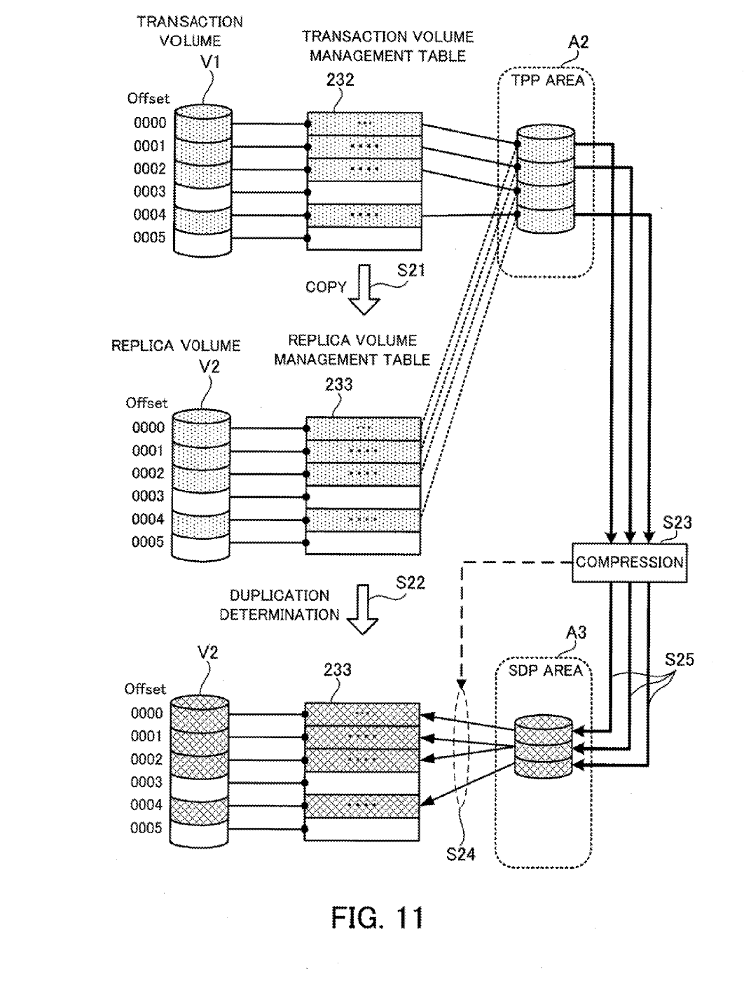

FIG. 11 illustrates an example of the replica volume generating process. Assume in FIG. 11 that a request for replication processing with respect to Offsets #0000 to #0005 in the transaction volume V1 is issued from the host device 400 while data is stored in Offsets #0000 to #0002, and #0004 in the transaction volume V1.

On receiving the replication request, the replication control unit 223 first copies entries corresponding to the replication target area (i.e., Offsets #0000 to #0005) in the transaction volume management table 232 to the replica volume management table 233 (Step S21). With this, the replica volume V2 is logically generated. That is, TPP blocks allocated to Offsets #0000 to #0002, and #0004 in the transaction volume V1, which is a replication source, are temporarily allocated to Offsets #0000 to #0002, and #0004 in the replica volume V2, in which offsets data is stored. In this condition, for example, a data read operation of reading data from the replication volume V2 may be performed according to a request from the host device 400. Thus, by copying the entries of the replication target area in the transaction volume management table 232 to the replica volume management table 233, it is possible to immediately bring the replica volume V2 into a usable state.

Next, based on codes registered in the replica volume management table 233, the replication control unit 223 determines, in the replica volume V2, offsets in which identical data is stored (Step S22). Assume in the example of FIG. 11 that it is determined that identical data is stored in Offsets #0001 and #0002. The replication control unit 223 performs de-duplication by allocating the same SDP block to Offsets #0001 and #0002 in which identical data is stored.

The replication control unit 223 reads data, via the RAID control unit 221, from the TPP blocks allocated to Offsets #0000, #0001, and #0004 in which different data from each other is stored, and compresses the data read from each of the TPP blocks using lossless compression (Step S23). The replication control unit 223 acquires, from the free area, a physical storage area (an SDP block) having a capacity equal to the amount of the compressed data with respect to each of Offsets #0000, #0001, and #0004. Subsequently, the replication control unit 223 registers location information of the acquired physical storage areas individually in the entries of Offsets #0000, #0001, and #0004 in the replica volume management table 233, to thereby change allocation of the physical storage areas (Step S24). At this point, the replication control unit 223 registers the same location information as for Offset #0001 in the entry of Offset #0002.

The replication control unit 223 further updates the pool area management table 231, to thereby exclude the acquired physical storage areas from the free area and add the acquired physical storage areas to the SDP area A3. With this, the acquired physical storage areas are treated as SDP blocks.

The replication control unit 223 performs the above-described process of registration to the replication volume management table 233, and also passes the location information of the acquired SDP blocks and the compressed data to be written to each of the SDP blocks on to the RAID control unit 221 and requests the RAID control unit 221 to write the compressed data to the SDP blocks. With this, the compressed data is written to the SDP blocks respectively allocated to Offsets #0000 to #0002, and #0004 of the replica volume V2 (Step S25).

According to the above-described operation, the process of generating the replica volume V2 is completed. The replica volume V2 is generated as a virtual volume, and physical storage areas are allocated to the replica volume V2 not from a dedicated area but from the common pool area shared with the transaction volume. With this, it is possible to efficiently use storage areas provided by the HDDs in the DE 300.

In addition, in the end, the same number of SDP blocks as offsets in which different data from each other is stored are allocated to the replica volume V2. Furthermore, each of the SDP blocks is provided with only a capacity for the compressed data. As a result, it is possible to reduce the capacity of each physical storage area actually allocated to the replica volume V2 compared to each physical storage area allocated to the replication source.

Furthermore, a reduction in the capacity of physical storage areas allocated to the replica volume V2 leads to a reduction in load of the data storing process for the allocated physical storage areas. Accordingly, it is possible to reduce the influence of the process of generating the replica volume V2 on the I/O processing to the transaction volume V1 executed according to a request from the host device 400, which prevents degradation of the performance of the I/O processing.

In addition, in the early stage where a replication request is received from the host device 400, the replica volume V2 is logically generated by copying a table, and subsequently, substantive data transfer to physical storage areas dedicated to the replica volume V2 (that is, SDP blocks) is carried out. According to such procedures, it is possible to execute the data storing process to the SDP blocks at an arbitrary timing after the reception of the replication request, such as during the period of time when I/O requests for the transaction volume V1 occur less frequently. In this case, degradation of the performance of the I/O processing to the transaction volume V1 may be further prevented.

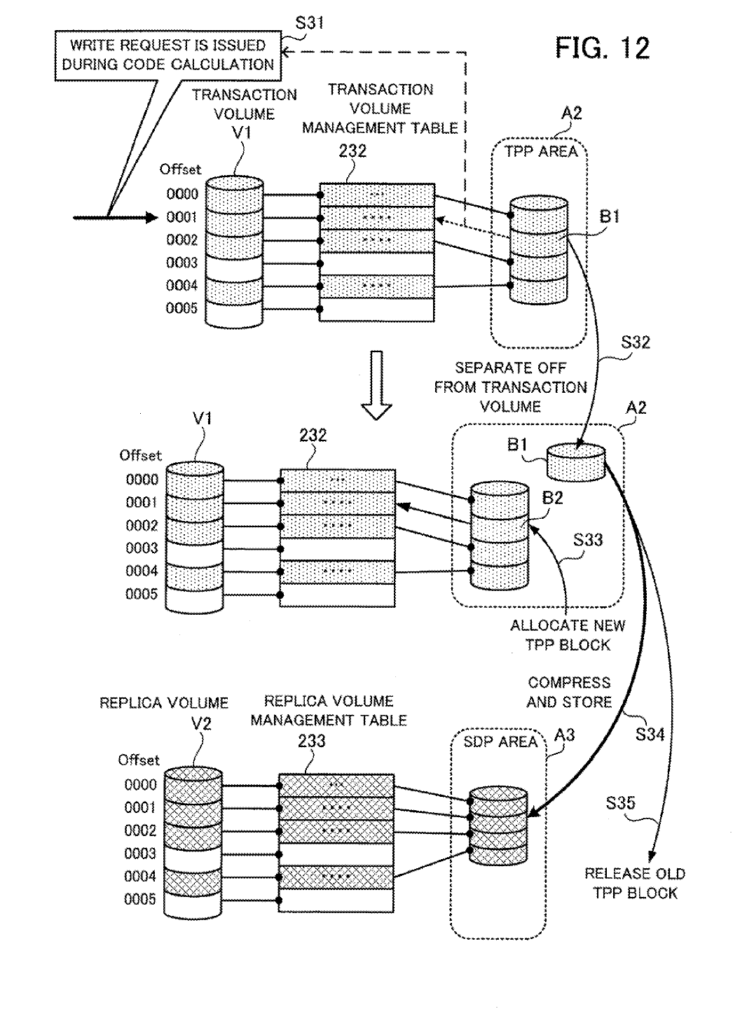

The host I/O control unit 222 asynchronously carries out the data write operation to TPP blocks in response to a request from the host device 400 and the code calculation operation based on the written data, as described with reference to FIG. 10. Therefore, for example, while the code calculation operation based on data stored in an offset of the transaction volume has yet to be completed, a data write request for the offset may be newly issued. Such a case may occur, for example, in the case where data write to the same area in the transaction volume is requested in succession. In this situation, a longer time is required for the write operation if new data write is withheld until the code calculation operation is completed. In view of the problem, a process illustrated in FIG. 12 is carried out to prevent an increase in the write operation time.

FIG. 12 illustrates an example of processing performed in response to a write request newly issued when code calculation has yet to be completed.

Assume in FIG. 12 that during a code calculation operation based on data stored in Offset #0001 of the transaction volume V1, a data write request for Offset #0001 is newly issued from the host device 400 (Step S31). Since the status in the entry of Offset #0001 in the transaction volume management table 232 is “calculation in progress”, the host I/O control unit 222 recognizes that the code calculation operation for Offset #0001 has yet to be completed.

In this case, the host I/O control unit 222 separates off a TPP block B1 having been allocated to Offset #0001 of the transaction volume V1 (Step S32), and acquires a new TPP block B2 from the free area and allocates the TPP block B2 to Offset #0001 (Step S33). Specifically, the host I/O control unit 222 overwrites the entry of Offset #0001 in the transaction volume management table 232 with the location information of the new TPP block B2. At this point, the host I/O control unit 222 updates the free flag in the entry of Offset #0001 in the replica volume management table 233 to “1”, to thereby record that the TPP block B1 is being saved. The host I/O control unit 222 writes data received from the host device 400 to the TPP block B2 newly allocated. This eliminates the need for waiting for the completion of the code calculation operation and enables the write operation to be performed at high speed.

On the other hand, after the code calculation for Offset #0001 of the replication volume V2 is completed, the replication control unit 223 performs de-duplication based on the calculated code and allocates an SDP block. At the time of Step S32 above, although the TPP block B1 is separated off from the transaction volume V1, the location information of the TPP block B1 is registered in the entry of Offset #0001 in the replica volume management table 233. Therefore, with the operations of Steps S22 to S25 of FIG. 11, the replication control unit 223 allocates an SDP block to Offset #0001 of the replica volume V2, then compresses data stored in the TPP block B1, and stores the compressed data in the SDP block (Step S34).

In addition, since the free flag corresponding to Offset #0001 in the replica volume management table 233 is “1”, the replication control unit 223 recognizes that the TPP block B1 is being saved. In this case, because the new TPP block B2 has been allocated to Offset #0001 of the transaction volume V1, data of the TPP block B1 is unnecessary. Therefore, the replication control unit 223 updates the pool area management table 231, to thereby release the TPP block B1 from the TPP area A2 and return the TPP block B1 to the free area (Step S35).

According to the above-described operations, both the old and new data for Offset #0001 of the transaction volume V1 are temporarily stored in the TPP area A2. However, after the data read operation from the TPP area A2 by the replication control unit 223 is finished, the TPP area A2 is returned to the free area A1 and becomes available again. Accordingly, it is possible to reduce the capacity of the physical storage area needed while preventing a decrease in the speed of the write operation according to a request from the host device 400.

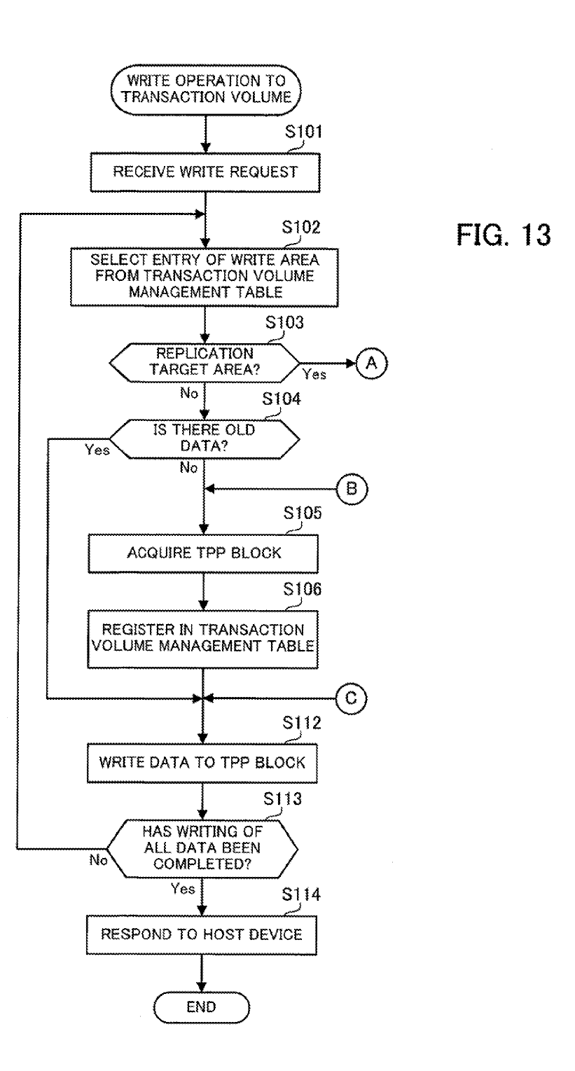

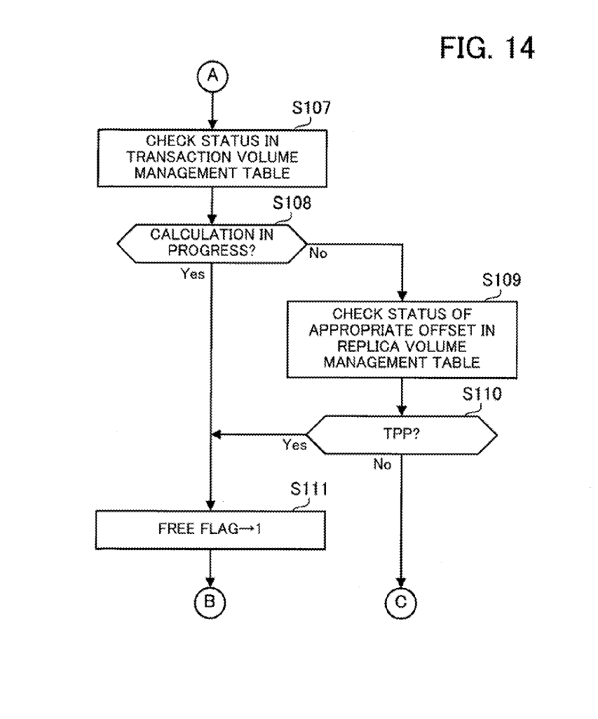

Next described is the process illustrated in FIGS. 10 to 12 using flowcharts. FIGS. 13 and 14 are flowcharts illustrating an example of data write procedures with respect to the transaction volume according to a request from a host device.

[Step S101] The host I/O control unit 222 receives a write request for the transaction volume from the host device 400.

[Step S102] The host I/O control unit 222 selects, from among the entries of the transaction volume management table 232, one entry included in an area within the transaction volume, targeted by the write request (hereinafter the “write-request target area”).

[Step S103] The host I/O control unit 222 determines whether the selected entry has been designated as a replication target area. The host I/O control unit 222 determines that the selected entry has been designated as a replication target area when the location information (the volume number and the LBA) of a TPP block registered in the selected entry is registered in the replication range setup table 234.

Note that, in the case where the location information of the TPP block registered in the selected entry is registered in the replication range setup table 234, the replication processing for a replica volume with respect to an area including the entry is in execution, and data has already been stored in an offset corresponding to the entry.

When determining that the selected entry has been designated as a replication target area (S103: Yes), the host I/O control unit 222 advances the process to Step S107 of FIG. 14. On the other hand, when determining the selected entry is not designated as a replication target area (S103: No), the host I/O control unit 222 advances the process to Step S104.

[Step S104] The host I/O control unit 222 determines whether data has already been stored in the selected entry (that is, whether the current operation is a new write operation to an unused area in the transaction volume). In the case where data has already been stored (S104: Yes), the host I/O control unit 222 advances the process to Step S112. On the other hand, if data has not been stored (S104: No), the host I/O control unit 222 advances the process to Step S105.

[Step S105] The host I/O control unit 222 acquires a fixed capacity of a physical storage area from the free area as a TPP block. At this point, the host I/O control unit 222 updates the pool area management able 231 in such a manner as to exclude the acquired physical storage area from the free area and add the acquired physical storage area to the TPP area.

[Step S106] The host I/O control unit 222 registers the location information (the volume number, the LBA and the number of blocks) of the acquired TPP area in the selected entry of the transaction volume management table 232. With this, the acquired TPP block is allocated to an offset corresponding to the selected entry.

[Step S107] In the case where the selected entry has been designated as a replication target area (S103: Yes), the host I/O control unit 222 checks the status of the selected entry in the transaction volume management table 232.

[Step S108] In the case where the status is “calculation in progress” (S108: Yes), the host I/O control unit 222 advances the process to Step S111. On the other hand, if the status is “TPP” (S108: No), the host I/O control unit 222 advances the process to Step S109.

[Step S109] The host I/O control unit 222 refers to, among the entries in the replica volume management table 233, an entry in which the same offset number is registered as for the entry selected in Step S102 and checks the status of the entry referred to.

[Step S110] In the case where the status is “TPP” (S110: Yes), the host I/O control unit 222 advances the process to Step S111. On the other hand, if the status is not “TPP” (S110: No; specifically, if the status is “SDP”), the host I/O control unit 222 advances the process to Step S112 of FIG. 13.

[Step S111] The host I/O control unit 222 refers to, among the entries in the replica volume management table 233, an entry in which the same offset number is registered as for the entry selected in Step S102 and updates, to “1”, the free flag in the entry referred to. Subsequently, the operation of Step S105 of FIG. 13 is carried out.

[Step S112] The host I/O control unit 222 passes the location information of the TPP block registered in the entry selected in Step S102 and data to be written to the TPP block on to the RAID control unit 221 and requests the RAID control unit 221 to write the data to the TPP block. With this, the data requested to be written is stored in the TPP block allocated to the selected entry.

For example, in the case where a “Yes” is obtained in Step S104 or a “No” is obtained in Step S110, data already stored in the TPP block is overwritten with new data in Step S112. In addition, when Step S112 is carried out following Step S106, data is stored in the newly allocated TPP block in Step S112.

In addition, the host I/O control unit 222 updates the status of the selected entry to “calculation in progress”.

[Step S113] The host I/O control unit 222 determines whether all of the requested data write operations have been completed. The host I/O control unit 222 determines that all the write operations are completed in the case, among the entries in the transaction volume management table 232, all entries included in the write-request target area of the transaction volume have been selected.

In the case where all the write operations have not been completed (S113: No), the host I/O control unit 222 returns to Step S102 and continues the process by selecting another entry from the transaction volume management table 232. On the other hand, if all the write operations have been completed (S113: Yes), the host I/O control unit 222 advances the process to Step S114.

[Step S114] The host I/O control unit 222 responds to the host device 400 and notifies the host device 400 of the completion of the requested write operations.

In the above-described processing illustrated in FIGS. 13 and 14, when a “Yes” is obtained in Step S108, the code calculation operation for old data stored in the TPP block corresponding to the entry selected in Step S102 is not yet completed. In this case, a new TPP block is allocated to the selected entry (Steps S105 and S106). On the other hand, the free flag of a corresponding entry in the replica volume management table 233 is updated to “1” (Step S111), and in this way, it is recorded that the original TPP block is being saved.

In addition, when a “Yes” is obtained in Step S110, the old data stored in the TPP block corresponding to the entry selected in Step S102 is not stored in an SDP block allocated to the replica volume. In this case also, a new TPP block is allocated to the selected entry (Steps S105 and S106), as in the above-described case. On the other hand, the free flag of a corresponding entry in the replica volume management table 233 is updated to “1” (Step S111), and in this way, it is recorded that the original TPP block is being saved.

Here, also in the case where the code calculation operation based on the old data stored in the TPP block corresponding to the selected entry is yet to be completed, the status of the corresponding entry in the replica volume management table 233 is “TPP”. However, when the code calculation operation based on the old data is yet to be completed, the operation of the step S111 is carried out simply by reading the registered information in the transaction volume management table 232 in Step S107 before referring to the replica volume management table 233 in Step S109. Therefore, the number of times of referring to the replica volume management table 233 is reduced, which in turn reduces processing load.

In addition, when a “Yes” is obtained in Step S108 or S110, the original TPP block is saved and a new TPP block is allocated. Here, at the time when the table copy operation described in Step S21 of FIG. 11 is carried out to save the TPP block, the location information of the TPP block to be saved is already registered in a corresponding entry in the replica volume management table 233. Therefore, in order to save the TPP block, all it takes is to update the free flag to “1” and allocate a new TPP block, and there is no need to perform processing of reading and writing the location information of the TPP block to be saved in order to record the location information in one of the tables. As a result, even in the case where data write to the same location is requested from the host device 400 in succession, it is possible to prevent a decrease in the speed of the write operation by simple procedures.

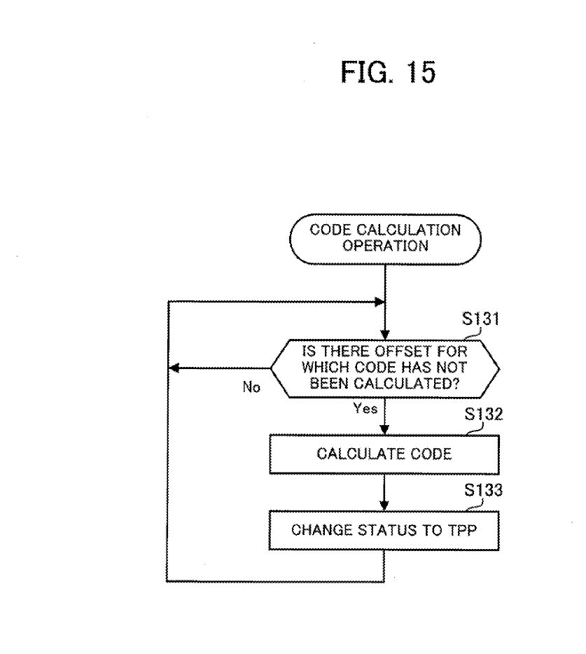

FIG. 15 is a flowchart illustrating an example of code calculation procedures. The host I/O control unit 222 asynchronously executes the process of FIGS. 13 and 14 and the process of FIG. 15.

[Step S131] The host I/O control unit 222 monitors each entry of the transaction volume management table 232, and advances the process to Step S132 when detecting an offset for which a code has not been calculated (S131: Yes).

[Step S132] Based on the location information corresponding to the offset for which a code has not been calculated, the host I/O control unit 222 reads data from a TPP block indicated by the location information and calculates a code. The host I/O control unit 222 registers the calculated code in the entry corresponding to the offset.

[Step S133] The host I/O control unit 222 changes the status of the entry in which the code is registered from “calculation in progress” to “TPP”. Subsequently, the host I/O control unit 222 returns to Step S131.

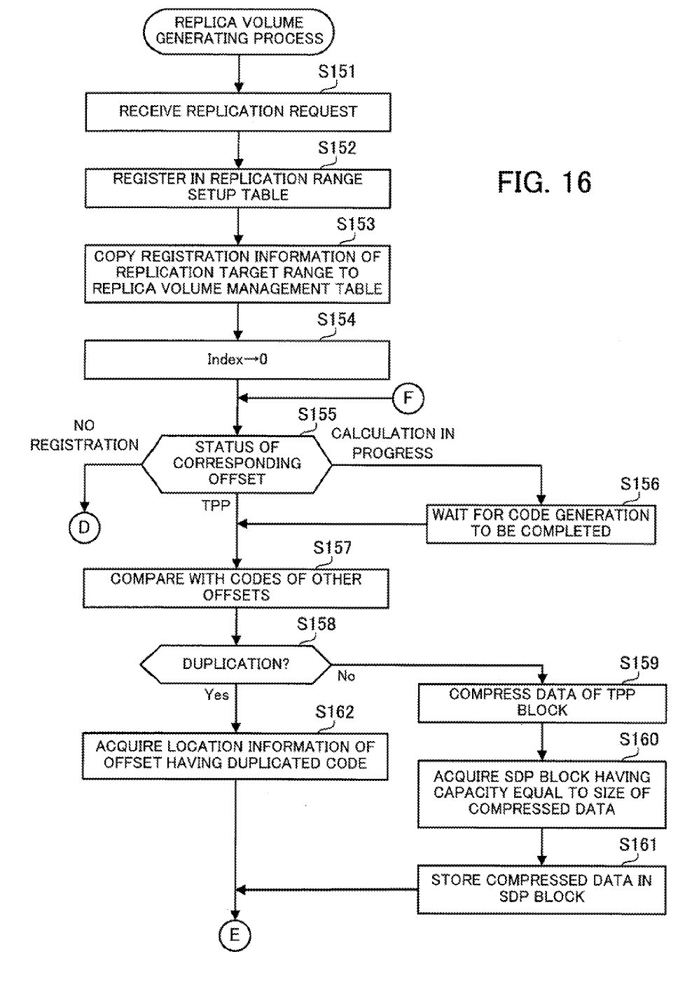

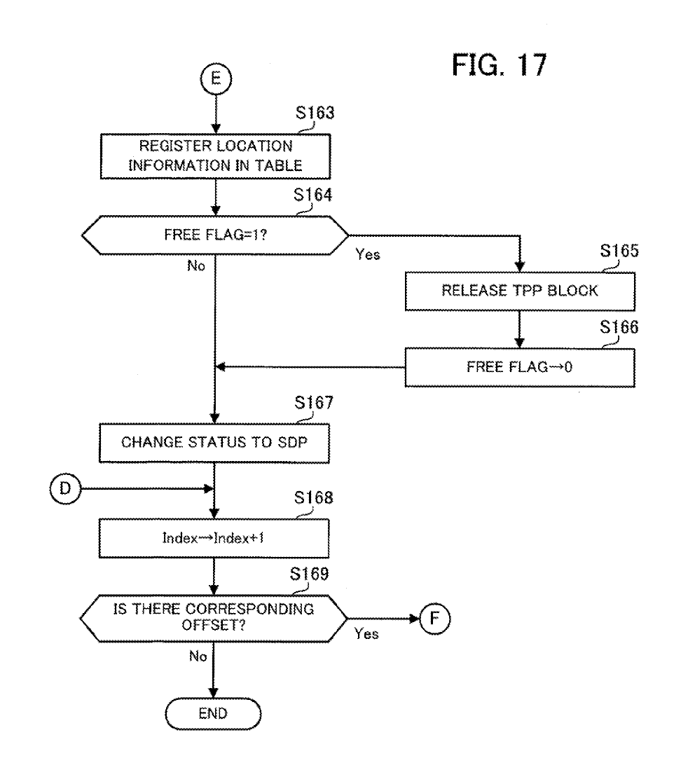

FIGS. 16 and 17 are flowcharts illustrating an example of replica volume generating procedures.

[Step S151] The host I/O control unit 222 receives a replication request from the host device 400. At this time, the host I/O control unit 222 receives, from the host device 400, a designation of a replication target range in the transaction volume. The host I/O control unit 222 notifies the replication control unit 223 of the designated replication target range and causes the replication control unit 223 to start a replication volume generating process.

[Step S152] The replication control unit 223 refers to the transaction volume management table 232 and registers, in the replication range setup table 234, the location information indicating physical storage areas allocated to the designated replication target range.

[Step S153] The replication control unit 223 copies, to the replica volume management table 233, information of entries included in the replication target range among the entries of the transaction volume management table 232. With this, TPP blocks are temporarily allocated to, among offsets of a replica volume, offsets in which data is stored. Thus, a replica volume is logically generated.

Note that the replication control unit 223 sets “0” in the free flag of the entry copied to the transaction volume management table 232.

[Step S154] The replication control unit 223 sets a variable Index to an initial value “0”. The Index is assigned to each entry of the replica volume management table 233, starting from the first entry with the initial value “0”.

[Step S155] The replication control unit 223 refers to the status of an entry indicated by the variable Index. In the case where the status is “calculation in progress”, the replication control unit 223 advances the process to Step S156. In addition, when the status is “TPP”, the replication control unit 223 advances the process to Step S157. Further, when no registration has been made in the status (that is, no data is registered in a corresponding offset), the replication control unit 223 advances the process to Step S168 of FIG. 17.

[Step S156] When the status is “calculation in progress”, the code calculation operation based on data stored in the corresponding offset in the transaction volume has yet to be completed. In this case, the replication control unit 223 waits for the code calculation operation to be completed. When the status of the entry indicated by the variable Index is changed from “calculation in progress” to “TPP”, the replication control unit 223 advances the process to Step S157.

[Step S157] The replication control unit 223 compares a code registered in the entry indicated by the variable Index with a code registered in each entry located on the first entry side before the entry indicated by the variable Index.

[Step S158] The replication control unit 223 determines whether there is another offset having duplicated data. In the case of detecting an entry in which the same code is registered in Step S157, the replication control unit 223 determines that there is another offset having duplicated data. In the case where there is no other offset having duplicated data (S158: No), the replication control unit 223 advances the process to Step S159. On the other hand, when there is another offset having duplicated data (S158: Yes), the replication control unit 223 advances the process to Step S162.

[Step S159] When it is determined that there is no other offset having duplicated data (S158: No), a new SDP offset is to be acquired, and data is to be written to the acquired SDP offset. In this case, the replication control unit 223 first notifies the RAID control unit 221 of the location information registered in the entry indicated by the variable Index and requests the RAID control unit 221 to read data from a TPP block indicated by the location information. The replication control unit 223 compresses the data read from the TPP block by the RAID control unit 221 using lossless compression.

Note that the replication control unit 223 temporarily records, in the RAM 212, the location information indicating the TPP block from which the data is read.

[Step S160] The replication control unit 223 acquires, from the free area, a physical storage area having a capacity equal to the amount of the compressed data as an SDP block. At this point, the replication control unit 223 updates the pool area management table 231 in such a manner as to exclude the acquired physical storage area from the free area and add the acquired physical storage area to the SDP area.

[Step S161] The replication control unit 223 passes the location information (the volume number, the LBA and the number of blocks) of the acquired SDP block and the compressed data on to the RAID control unit 221 and requests the RAID control unit 221 to write the compressed data to the acquired SDP block. With this, the compressed data is stored in the acquired SDP block. Subsequently, Step S163 of FIG. 17 is carried out.

[Step S162] The replication control unit 223 acquires location information (the volume number, the LBA and the number of blocks) registered in the other entry whose code is matched in Step S157.

[Step S163] The replication control unit 223 registers, in the entry indicated by the variable Index, the location information of the SDP block acquired in Step S160 or the location information acquired in Step S162.

[Step S164] The replication control unit 223 refers to a free flag of the entry indicated by the variable Index. In the case of where the free flag is “1” (S164: Yes), the replication control unit 223 advances the process to Step S165. On the other hand, when the free flag is “0” (S164: No), the replication control unit 223 advances the process to Step S167.

[Step S165] The replication control unit 223 releases the TPP block indicated by the location information temporarily recorded in the RAM 212 in Step S159. The replication control unit 223 updates the pool area management table 231 in such a manner as to exclude the TPP block from the TPP area and add the TPP block to the free area. With this, the TPP block being saved becomes available again as another TPP block or SDP block.

[Step S166] The replication control unit 223 updates the free flag of the entry indicated by the variable Index from “1” to “0”.

[Step S167] The replication control unit 223 updates the status of the entry indicated by the variable Index from “TPP” to “SDP”. According to the operations of Step S163 and S167, the physical storage area allocated to the offset corresponding to the entry is changed from a TPP block to an SDP block.

[Step S168] The replication control unit 223 increments the value of the variable Index by “1”.

[Step S169] The replication control unit 223 determines whether there is an entry indicated by the incremented variable Index in the replica volume management table 233. In the case where there is such an entry (S169: Yes), the replication control unit 223 returns to Step S155 and continues the process using the entry as a processing target. On the other hand, if there is no such an entry (S169: No), the replication volume generating process is completed.

According to the above-described process, SDP blocks with the minimum necessary capacity are allocated as physical storage areas of the replica volume. In addition, in the generated replica volume, data is stored in different physical storage areas from those in the transaction volume which is a replication source. Further, in those physical storage areas, data is stored in such a manner that all data stored in the replication source areas is completely restorable. Therefore, for example, in the case where a part of the physical storage areas allocated to the replication-source transaction volume fails and access to data of the replication source becomes not available, data of the replication-source transaction volume at the time of the replication request may be completely restored from the replica volume.

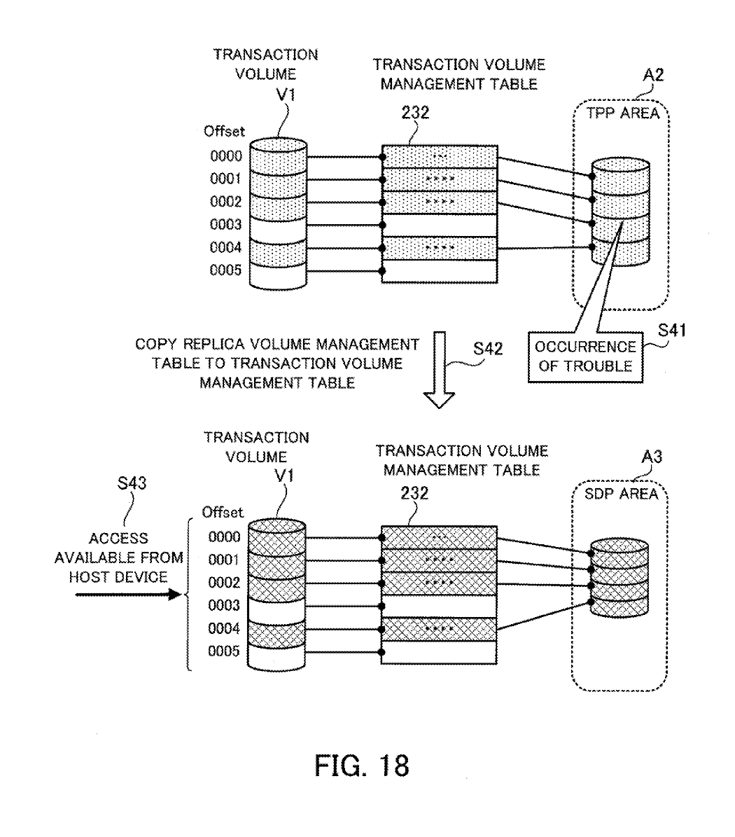

FIG. 18 illustrates an example of a restoration process using the replica volume.

Assume in FIG. 18 that a trouble has occurred in a part of TPP blocks allocated to the transaction volume V1 and access to Offsets #0000 to #0005 of the transaction volume V1 becomes unavailable (Step S41). Also assume that by the above-described process of FIGS. 16 and 17, a replica volume has been generated with Offsets #0000 to #0005 of the transaction volume V1 being the replication target range.

The restoration process for Offsets #0000 to #0005 of the transaction volume V1 is carried out as follows. The replication control unit 223 copies over entries of the transaction volume management table 232 with entries of the corresponding offsets of the replica volume management table 233 (Step S42).

With this, SDP blocks are allocated to offsets of the transaction volume V1, in which data is stored (Offsets #0000 to #0002, and #0004 according to the example of FIG. 18), and Offsets #0000 to #0005 of the transaction volume V1 are logically restored. At this time, if a read request to read data from Offsets #0000 to #0005 of the transaction volume V1 is issued from the host device 400, the host I/O control unit 222 reads data from the SDP blocks allocated to Offsets #0000 to #0005 and expands the data, to thereby respond to the host device 400 (Step S43).

Thus, by simply copying data registered in the table, it is possible to restore the transaction volume in a very short time, which enables I/O processing according to a request from the host device 400 to be continued in a stable condition.

Note that as a matter of course, restoration involving substantive data movement may be performed by newly allocating TPP blocks to the transaction volume V1, access to which is not available, and storing, in the allocated TPP blocks, the data read from the SDP blocks of the replica volume and expanded.

### (c) Third Embodiment

In the above-described second embodiment, the capacity of physical storage areas allocated to the replica volume is reduced by de-duplication and data compression. However, if the size of the transaction volume, which is a replication source, may also be reduced, it is possible to secure more free area in the pool area and increase the data storage capacity of the storage system as a whole.

Some data among data stored in the transaction volume has an extremely low access frequency. In view of this, according to a third embodiment below, de-duplication and data compression are performed on, among data stored in the transaction volume, data to which no access is made over a predetermined time period, as in the case of the replica volume. With this, the individual de-duplication and data compression processes are carried out with little influence on the speed of an I/O processing according to a request from the host device 400, which results in a reduction in the size of the physical storage areas allocated to the transaction volume.

Note that the hardware configuration and processing function configuration of the storage system according to the third embodiment are the same as those of the second embodiment. Therefore, the following description related to processing of the CM according to the third embodiment is given using reference numerals of FIG. 4, with a main focus on different processing and components from those of the second embodiment.

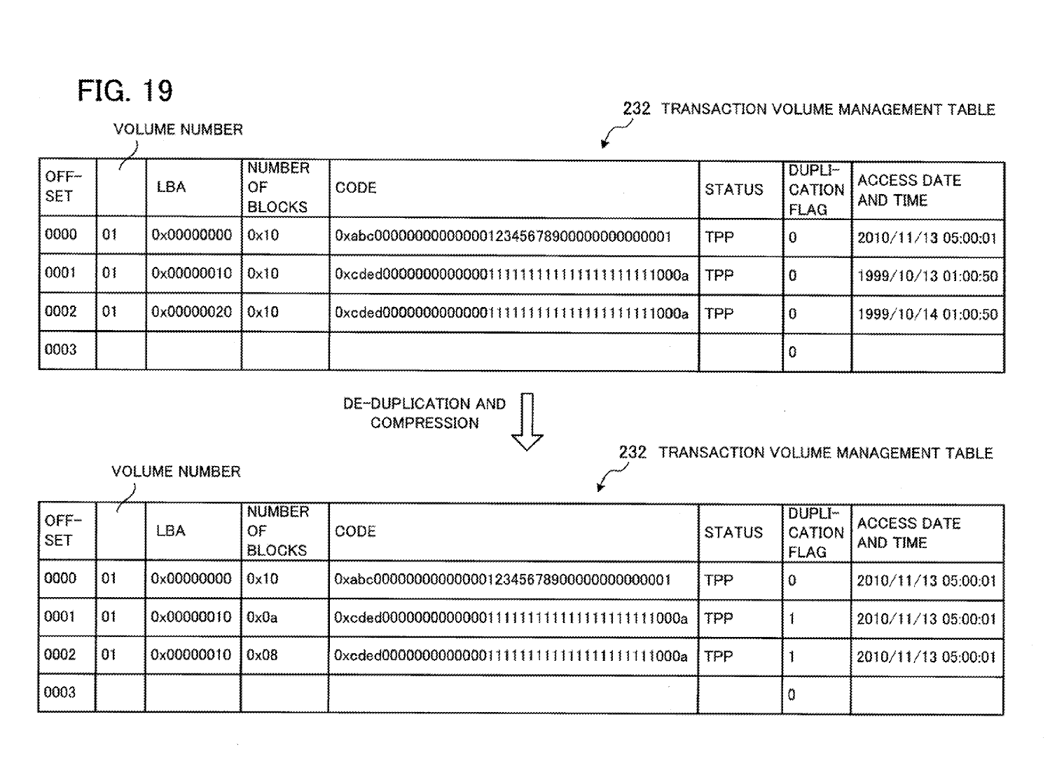

FIG. 19 illustrates an example of information registered in a transaction volume management table according to the third embodiment.

In the transaction volume management table 232, items of “duplication flag” and “access date and time” in addition to the items illustrated in FIG. 7 are registered for each entry of the individual offsets in the transaction volume. The duplication flag indicates whether data of a corresponding offset is overlapped with data of another offset. If the data of the offset is determined to be overlapped with the data of another offset when the de-duplication operation is performed on the transaction volume, the duplication flag is set to “1”, and in the other case, the duplication flag is set to “0”. In addition, the initial value of the duplication flag is also “0”. The access date and time indicates the last date and time that the RAID control unit 221 performed a data write operation or a data read operation with respect to the offset.

Each time a data write operation or a data read operation is performed with respect to the transaction volume, the RAID control unit 221 overwrites a corresponding entry of each offset in the transaction volume management table 232 with the current date and time (i.e., the time of the operation). In addition, in the case where the duplication flag corresponding to an offset is “1” when the RAID control unit 221 has performed a data write operation to write data to the offset, the RAID control unit 221 updates the duplication flag to “0”.

FIG. 19 illustrates conditions of the transaction volume management table 232 before and after execution of the capacity reduction process due to de-duplication and data compression. For example, assume that a predetermined time period has elapsed from the last access date and time of Offset #0001 when Offsets #0000 to #0003 of the transaction volume are brought into the state illustrated in the upper part of FIG. 19. The host I/O control unit 222 detects an offset associated with the same code as a code associated with Offset #0001. According to the example of FIG. 19, Offset #0002 is detected as an offset associated with the same code.

The host I/O control unit 222 reads data from a TPP block allocated to Offset #0001 and compresses the data, and newly acquires a TPP block having a capacity equal to the amount of the compressed data from the free area. The host I/O control unit 222 stores the compressed data in the acquired TPP block, and also overwrites each entry corresponding to individual Offsets #0001 and #0002 with the location information (the volume number, the LBA and the number of blocks) of the TPP block. Further, the host I/O control unit 222 updates the duplication flag of each entry of Offsets #0001 and #0002 from “0” to “1”. The lower part of FIG. 19 illustrates the transaction volume management table 232 obtained after the above-described update process is performed.

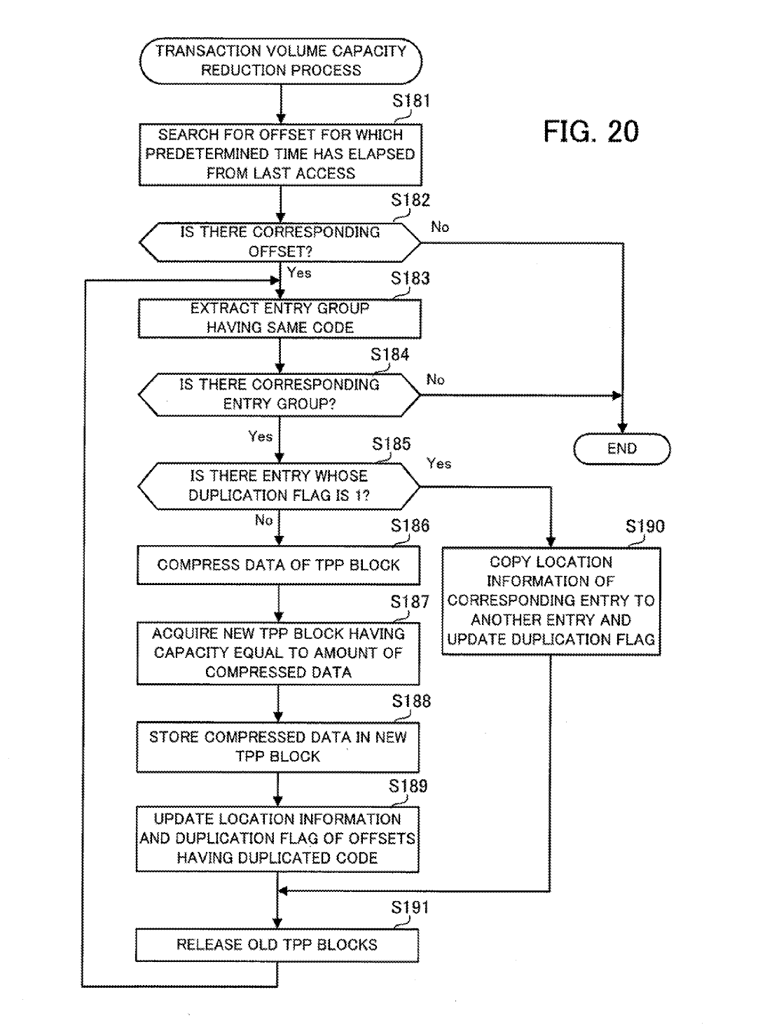

FIG. 20 is a flowchart illustrating an example of procedures for reducing storage capacity of a transaction volume. The process of FIG. 20 is, for example, executed at regular intervals. It is preferable that the process of FIG. 20 be executed, for example, during the time when there is a low frequency of I/O requests from the host device 400.

[Step S181] The host I/O control unit 222 refers to the access date and time of each entry in the transaction volume management table 232 and searches for an offset for which a predetermined time period (for example, three years) has elapsed from the registered access date and time.

[Step S182] When detecting one or more offsets meeting the condition in Step S181 (S181: Yes), the host I/O control unit 222 records the numbers of all the detected offsets in the RAM 212, and advances the process to Step S183. On the other hand, if no offset matching the condition is detected in Step S181, the host I/O control unit 222 ends the capacity reduction process.

[Step S183] Among entries corresponding to the offsets recorded in the RAM 212 in Step S182, the host I/O control unit 222 extracts, as an entry group, entries in which codes having the same value are registered. Note that, in this operation, a plurality of entry groups each of which has a registered code of a different value may be extracted. In the case where a plurality of entry groups is extracted, the host I/O control unit 222 selects one of the entry groups and performs the following operations.

[Step S184] In the case where an entry group is extracted in Step S183 (S184: Yes), the host I/O control unit 222 advances the process to Step S185. On the other hand, if no entry group is extracted in Step S183 (S184: No), the host I/O control unit 222 ends the capacity reduction process.

[Step S185] The host I/O control unit 222 determines whether there is an entry whose duplication flag is “1” in the entry group selected in Step S183. In the case where there is an entry whose duplication flag is “1” (S185: Yes), the host I/O control unit 222 advances the process to Step S190. On the other hand, if there is no entry whose duplication flag is “1” (S185: No), the host I/O control unit 222 advances the process to Step S186.

[Step S186] The host I/O control unit 222 selects one entry (for example, an entry having the smallest offset number) from the entry group selected in Step S183. The host I/O control unit 222 notifies the RAID control unit 221 of location information registered in the selected entry and requests the RAID control unit 221 to read data from a TPP block indicated by the location information. The host I/O control unit 222 compresses the data read from the TPP block by the RAID control unit 221 using lossless compression.

[Step S187] The host I/O control unit 222 acquires, as a TPP block, a physical storage area having a capacity equal to the amount of the compressed data from the free area. At this time, the host I/O control unit 222 updates the pool area management table 231 in such a manner as to exclude the acquired physical storage area from the free area and add the acquired physical storage area to the TPP area.

[Step S188] The host I/O control unit 222 passes the location information (the volume number, the LBA and the number of blocks) of the acquired TPP block and the compressed data on to the RAID control unit 221 and requests the RAID control unit 221 to write the compressed data in the acquired TPP block. With this, the compressed data is stored in the newly acquired TPP block.

[Step S189] The host I/O control unit 222 temporarily records, in the RAM 212, location information of TPP blocks registered in all entries of the entry group selected in Step S183. Then, the host I/O control unit 222 overwrites all the entries included in the entry group selected in Step S183 with the location information of the TPP block acquired in Step S187. Further, the host I/O control unit 222 updates the duplication flag of each of the entries from “0” to “1”.

[Step S190] Since an entry whose duplication flag is “1” has an already allocated TPP block in common with another entry, and compressed data is stored in the TPP block. Therefore, in the case where an entry whose duplication flag is “1” is present in the entry group (S185: Yes), there is no need to newly acquire a TPP block and the TPP block registered in the entry whose duplication flag is “1” may be used.

The host I/O control unit 222 temporarily records, in the RAM 212, location information of TPP blocks registered in, among the entries of the entry group selected in Step S183, all entries whose duplication flag is “0”. The host I/O control unit 222 copies over the entries whose duplication flag is “0” in the entry group with the location information of the TPP block registered in the entry whose duplication flag is “1” in the entry group. In addition, the host I/O control unit 222 updates the duplication flag of the entries whose location information is copied over from “0” to “1”.

[Step S191] The host I/O control unit 222 releases the TPP blocks indicated by the location information temporarily recorded in the RAM 212 in Step S189 or S190. The host I/O control unit 222 updates the pool area management table 231 in such a manner as to exclude these TPP blocks from the TPP area and add the TPP blocks to the free area. With this, the TPP blocks in which identical data were stored without compression become available as other TPP blocks or SDP blocks.

Subsequently, the process returns to Step S183, and if another entry group is extracted (S184: Yes), the operations from Step S185 onward are performed with respect to the extracted entry group.

According to the process of FIG. 20, a common TPP block having a capacity equal to the amount of the compressed data is allocated to, among the offsets in the transaction volume, offsets to which access has not been made for a predetermined period of time or longer. This reduces the capacity of physical storage areas allocated to the transaction volume.

Here, in the case where a data read request for reading data from an offset to which the common TPP block has been allocated is issued, the time for responding to the read request becomes longer because the data read from the TPP block needs to be expanded. However, access has not been made for long time to the offset to which the common TPP block has been allocated, and it is less likely that access will be made to the offset in the future. Accordingly, even if the process of FIG. 20 is executed, it is not likely that the speed of I/O processing according to a request from the host device 400 is reduced. That is, it is possible to reduce the amount of physical storage areas used in the storage system while decreasing the speed of the I/O processing as little as possible.

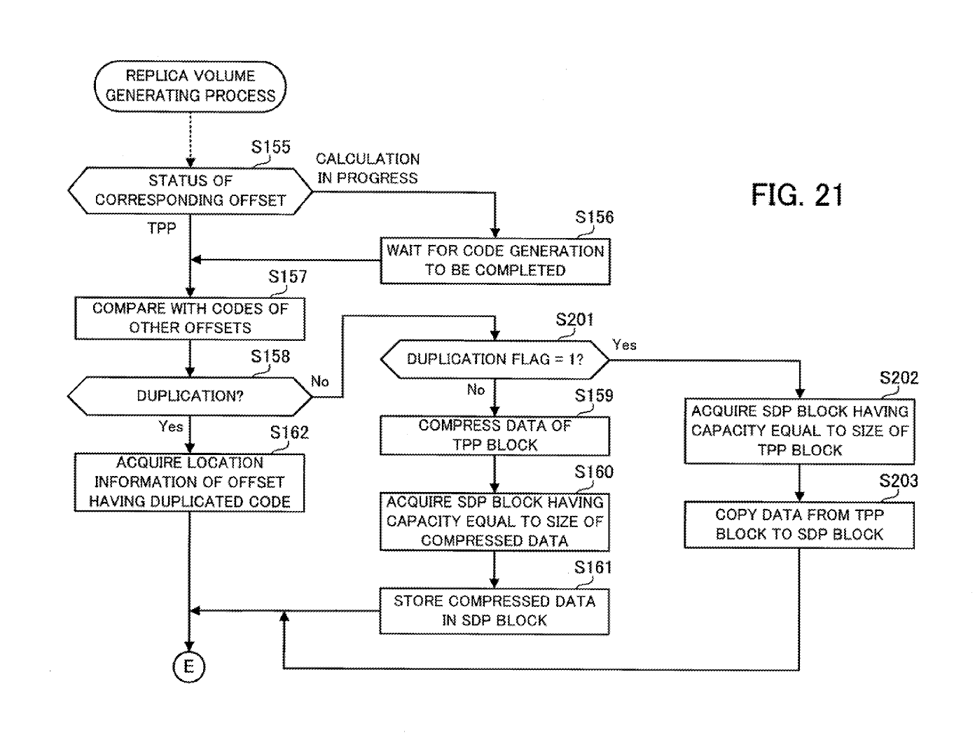

Note that the duplication flag registered in the transaction volume management table 232 may be used at the time of generating a replica volume as illustrated FIG. 21 below.

FIG. 21 is a flowchart illustrating an example of replica volume generating procedures according to the third embodiment. Note that in FIG. 21, the same step numbers are given to operational steps which are common to those of FIG. 16, and the explanations of the operations are omitted.

In the process of FIG. 21, when a “No” is obtained in Step S158 of FIG. 16, the operation of Step S201 is performed.

[Step S202] When the duplication flag is “1” (S201: Yes), data already in a compressed form has been stored in a TPP block allocated to the entry. In this case, the replication control unit 223 acquires, from the free area as an SDP block, a physical storage area having a capacity equal to the amount of the TPP block allocated to the entry indicated by the variable Index (that is, a physical storage area having the same number of blocks registered in the entry). At this time, the replication control unit 223 updates the pool area management table 231 in such a manner as to exclude the acquired physical storage area from the free area and add the physical storage area to the SDP area.

[Step S203] The replication control unit 223 requests the RAID control unit 221 to copy data stored in the TPP block allocated to the entry indicated by the variable Index to the SDP block acquired in Step S202. With this, the compressed data is transferred from the TPP block to the SDP block.

Subsequently, Step S163 of FIG. 17 is performed. Note however that, in Step S163, the replication control unit 223 registers, to the entry indicated by the variable Index, one of the location information of the SDP block acquired in Step S160, the location information acquired in Step S162, and the location information of the SDP block acquired in Step S202.

According to the above-described process of FIG. 21, when the duplication flag registered to the processing target entry is “1”, the data compression operation is skipped. Accordingly, it is possible to reduce the time required for the replication volume generating process.

According to one aspect, the capacity of physical storage required for a replication destination of a volume may be reduced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A storage system comprising:
a plurality of storage apparatuses; and
a storage control apparatus configured to control reading and writing of data with respect to a volume made up of part of physical storage areas of the storage apparatuses,
wherein the storage control apparatus includes
a memory configured to store one or more codes, and
a processor configured to execute processing including:
writing data to a first volume in response to a request from a host apparatus and generating a code corresponding to written data with respect to each of partial areas formed by dividing the first volume, and then registering, in the memory, the generated codes in association with the individual partial areas; and
replicating, on receiving a replication request regarding a replication target area in the first volume, data of the replication target area to a second volume made up of different part of the physical storage areas from part of the physical storage areas constituting the first volume and determining, from among partial areas in the replication target area, partial areas in which identical data is stored based on the codes registered in the memory, and then allocating the same physical storage area to partial areas of the second volume corresponding to the partial areas in which the identical data is stored.

2. The storage system according to claim 1, wherein
the processor executes asynchronously the processing of writing data to the first volume in response to the request from the host apparatus and the processing of generating the code corresponding to the written data with respect to each of the partial areas and registering, in the memory, the generated codes in association with the individual partial areas.

3. The storage system according to claim 1, wherein
in the processing of replicating the data of the replication target area to the second volume,
the second volume is generated as a virtual volume by allocating a physical storage area acquired from an unused area of the storage apparatuses with respect to, among the partial areas in the replication target area, each partial area in which data is stored, and copying the stored data of the partial area to the allocated physical storage area.

4. The storage system according to claim 3, wherein
in the processing of replicating the data of the replication target area to the second volume,
when the replication request regarding the replication target area is received, each physical storage area allocated to one of the partial areas of the replication target area, in which partial areas data is stored, is allocated to a corresponding partial area in the second volume, and
subsequently, the physical storage area allocated to the corresponding partial area in the second volume is changed to the physical storage area acquired from the unused area, and data stored in the physical storage area before the change is copied to the corresponding physical storage area after the change.

5. The storage system according to claim 4, wherein
in the processing of writing data to the first volume,
the first volume is generated as a virtual volume by allocating a physical storage area acquired from the unused area to a partial area in which data is requested to be written from the host apparatus and storing, in the allocated physical storage area, the data requested to be written, and
at a time of writing data to the first volume in response to the request from the host apparatus, a new physical storage area acquired from the unused area is allocated to a write-destination partial area included in the replication target area and the data requested to be written from the host apparatus is written to the allocated physical storage area when the processing of replicating, to the second volume, the data of the replication target area including the write-destination partial area is in execution, data is already stored in the write-destination partial area, and copying of the already stored data to the second volume is yet to be completed.

6. The storage system according to claim 2, wherein
in the processing of replicating the data of the replication target area to the second volume,
the second volume is generated as a virtual volume by allocating a physical storage area acquired from an unused area of the storage apparatuses with respect to, among the partial areas in the replication target area, each partial area in which data is stored, and copying the stored data of the partial area to the allocated physical storage area, and
when the replication request regarding the replication target area is received, each physical storage area allocated to one of the partial areas of the replication target area, in which partial areas data is stored, is allocated to a corresponding partial area in the second volume, and subsequently, the physical storage area allocated to the corresponding partial area in the second volume is changed to the physical storage area acquired from the unused area, and data stored in the physical storage area before the change is copied to the corresponding physical storage area after the change, and
in the processing of writing data to the first volume,
the first volume is generated as a virtual volume by allocating a physical storage area acquired from the unused area to a partial area in which data is requested to be written from the host apparatus and storing, in the allocated physical storage area, the data requested to be written, and at a time of writing data to the first volume in response to the request from the host apparatus, a new physical storage area acquired from the unused area is allocated to a write-destination partial area included in the replication target area and the data requested to be written from the host apparatus is written to the allocated physical storage area when the processing of replicating, to the second volume, the data of the replication target area including the write-destination partial area is in execution, data is already stored in the write-destination partial area, and a code based on the already stored data is yet to be registered in the memory.

7. The storage system according to claim 6, wherein
in the processing of replicating the data of the replication target area to the second volume,
when the new physical storage area has been allocated to a partial area in the replication target area, which partial area corresponds to the corresponding partial area in the second volume, at a time when the physical storage area allocated to the corresponding partial area in the second volume is changed to the physical storage area acquired from the unused area, the physical storage area allocated to the corresponding partial area in the second volume before the change is set to be part of the unused area.

8. The storage system according to claim 3, wherein
in the processing of replicating the data of the replication target area to the second volume,
the data stored in the partial area in the replication target area is compressed, a physical storage area acquired from the unused area and having a capacity equal to an amount of the compressed data is allocated to a partial area in the second volume, which partial area corresponds to the partial area whose data is compressed, and the compressed data is stored in the allocated physical storage area.

9. The storage system according to claim 1, wherein the processing further includes extracting one or more partial areas to which no access is made over a predetermined time period, from partial areas of the first volume, in which partial areas data is stored, and allocating the same physical storage area among the extracted partial areas to partial areas in which the identical data is stored.

10. A storage control apparatus for controlling reading and writing of data with respect to a volume made up of part of physical storage areas of a plurality of storage apparatuses, the storage control apparatus comprising:
a memory configured to store one or more codes; and
a processor configured to execute processing including:
writing data to a first volume in response to a request from a host apparatus and generating a code corresponding to written data with respect to each of partial areas formed by dividing the first volume, and then registering, in the memory, the generated codes in association with the individual partial areas; and
replicating, on receiving a replication request regarding a replication target area in the first volume, data of the replication target area to a second volume made up of different part of the physical storage areas from part of the physical storage areas constituting the first volume and determining, from among partial areas in the replication target area, partial areas in which identical data is stored based on the codes registered in the memory, and then allocating the same physical storage area to partial areas of the second volume corresponding to the partial areas in which the identical data is stored.

11. The storage control apparatus according to claim 10, wherein
the processor executes asynchronously the processing of writing data to the first volume in response to the request from the host apparatus and the processing of generating the code corresponding to the written data with respect to each of the partial areas and registering, in the memory, the generated codes in association with the individual partial areas.

12. A storage control method of a storage control apparatus for controlling reading and writing of data with respect to a volume made up of part of physical storage areas of a plurality of storage apparatuses, the storage control method comprising:
writing, by a processor, data to a first volume in response to a request from a host apparatus and generating a code corresponding to written data with respect to each of partial areas formed by dividing the first volume, and then registering, in the memory, the generated codes in association with the individual partial areas, and
replicating, by the processor, on receiving a replication request regarding a replication target area in the first volume, data of the replication target area to a second volume made up of different part of the physical storage areas from part of the physical storage areas constituting the first volume and determining, from among partial areas in the replication target area, partial areas in which identical data is stored based on the codes registered in the memory, and then allocating the same physical storage area to partial areas of the second volume corresponding to the partial areas in which the identical data is stored.

13. The storage control method according to claim 12, wherein
the writing data to the first volume in response to the request from the host apparatus and the generating the code corresponding to the written data with respect to each of the partial areas and registering, in the memory, the generated codes in association with the individual partial areas are asynchronously executed.

14. The storage control method according to claim 12, wherein
in the replicating the data of the replication target area to the second volume,
the second volume is generated as a virtual volume by allocating a physical storage area acquired from an unused area of the storage apparatuses with respect to, among the partial areas in the replication target area, each partial area in which data is stored, and copying the stored data of the partial area to the allocated physical storage area.

15. The storage control method according to claim 14, wherein
in the replicating the data of the replication target area to the second volume,
when the replication request regarding the replication target area is received, each physical storage area allocated to one of the partial areas of the replication target area, in which partial areas data is stored, is allocated to a corresponding partial area in the second volume, and
subsequently, the physical storage area allocated to the corresponding partial area in the second volume is changed to the physical storage area acquired from the unused area, and data stored in the physical storage area before the change is copied to the corresponding physical storage area after the change.

16. The storage control method according to claim 15, wherein
in the writing data to the first volume,
the first volume is generated as a virtual volume by allocating a physical storage area acquired from the unused area to a partial area in which data is requested to be written from the host apparatus and storing, in the allocated physical storage area, the data requested to be written, and
at a time of writing data to the first volume in response to the request from the host apparatus, a new physical storage area acquired from the unused area is allocated to a write-destination partial area included in the replication target area and the data requested to be written from the host apparatus is written to the allocated physical storage area when the replicating, to the second volume, the data of the replication target area including the write-destination partial area is in execution, data is already stored in the write-destination partial area, and copying of the already stored data to the second volume is yet to be completed.

17. The storage control method according to claim 13, wherein
in the replicating the data of the replication target area to the second volume,
the second volume is generated as a virtual volume by allocating a physical storage area acquired from an unused area of the storage apparatuses with respect to, among the partial areas in the replication target area, each partial area in which data is stored, and copying the stored data of the partial area to the allocated physical storage area, and
when the replication request regarding the replication target area is received, each physical storage area allocated to one of the partial areas of the replication target area, in which partial areas data is stored, is allocated to a corresponding partial area in the second volume, and subsequently, the physical storage area allocated to the corresponding partial area in the second volume is changed to the physical storage area acquired from the unused area, and data stored in the physical storage area before the change is copied to the corresponding physical storage area after the change, and
in the writing data to the first volume,
the first volume is generated as a virtual volume by allocating a physical storage area acquired from the unused area to a partial area in which data is requested to be written from the host apparatus and storing, in the allocated physical storage area, the data requested to be written, and at a time of writing data to the first volume in response to the request from the host apparatus, a new physical storage area acquired from the unused area is allocated to a write-destination partial area included in the replication target area and the data requested to be written from the host apparatus is written to the allocated physical storage area when the replicating, to the second volume, the data of the replication target area including the write-destination partial area is in execution, data is already stored in the write-destination partial area, and a code based on the already stored data is yet to be registered in the memory.

18. The storage control method according to claim 17, wherein
in the replicating the data of the replication target area to the second volume,
when the new physical storage area has been allocated to a partial area in the replication target area, which partial area corresponds to the corresponding partial area in the second volume, at a time when the physical storage area allocated to the corresponding partial area in the second volume is changed to the physical storage area acquired from the unused area, the physical storage area allocated to the corresponding partial area in the second volume before the change is set to be part of the unused area.

19. The storage control method according to claim 14, wherein
in the replicating the data of the replication target area to the second volume,
the data stored in the partial area in the replication target area is compressed, a physical storage area acquired from the unused area and having a capacity equal to an amount of the compressed data is allocated to a partial area in the second volume, which partial area corresponds to the partial area whose data is compressed, and the compressed data is stored in the allocated physical storage area.

20. The storage control method according to claim 12, wherein
one or more partial areas to which no access is made over a predetermined time period is extracted from partial areas of the first volume, in which partial areas data is stored, and the same physical storage area is allocated to, among the extracted partial areas, partial areas in which the identical data is stored.
